(19) United States
(12) Patent Application Publication
(10) Pub. No.: US 2009/0018326 A1
(43) Pub. Date: Jan. 15, 2009

(54) CELLULOSE ACYLATE FILM AND METHOD FOR PRODUCING THE SAME

(75) Inventor: Kiyokazu HASHIMOTO, Minami-ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM CORPORATION, Minato-ku (JP)

(21) Appl. No.: 12/062,238

(22) Filed: Apr. 3, 2008

(30) Foreign Application Priority Data
Apr. 4, 2007 (JP) 2007-098537

(51) Int. Cl. C08B 1/00

(52) U.S. Cl. 536/56

(57) ABSTRACT

A cellulose acylate film, which contains 1% to 25% by mass of a plasticizer and has a cellulose acylate composition satisfying the inequalities of 0≦X≦2.5 and 2.1≦X+Y≦3.0 (in which X is a substitution degree of acetyl group, and Y is a substitution degree of at least one group selected from propionyl, butyryl, and phthaloyl groups), is transversely stretched under conditions of [preheating temperature>stretching temperature] and [preheating zone length/stretching zone length=0.1 to 10]. After the transverse stretching, the film is heat-fixed under conditions of [stretching temperature>heat-fixing temperature] and [heat-fixing zone length/stretching zone length=0.1 to 10].

### BACKGROUND OF THE INVENTION

1. Field of the Invention

The present invention relates to a cellulose acylate film and a method for producing the same, and further relates to a polarizing plate, an optical compensatory film for a liquid crystal display panel, an antireflection film, and a liquid crystal display device using the cellulose acylate film.

2. Description of the Related Art

For the purpose of increasing the viewing angle of a liquid crystal display device, a thermoplastic film is stretched to generate an in-plane retardation Re and a thickness direction retardation Rth, and is used as a phase difference film for the liquid crystal device.

The thermoplastic film can be stretched by using a longitudinal stretching method for stretching the film in the longitudinal (length) direction, a transverse stretching method for stretching the film in the transverse (width) direction, a successive biaxial stretching method for stretching the film in the longitudinal and transverse directions successively, or a simultaneous biaxial stretching method for stretching the film in the longitudinal and transverse directions simultaneously.

A bowing phenomenon may cause a problem in such stretching methods. The bowing phenomenon is a phenomenon that, as shown in FIG. 6, when a film F having straight lines L extending in the width direction is transversely stretched in the direction of an arrow Y, the straight lines L are deformed into bow-like curved lines Lb in stretching.

When the film F is transversely stretched along such bow-like curved lines Lb, the center and both ends of the film F become different in the orientation angle (the direction in which molecules are aligned), whereby the resultant stretched film F is optically nonuniform in a retardation, an orientation angle, etc.

The bowing phenomenon is caused particularly frequently in the transverse stretching method, and various techniques for solving the problem have been proposed. For example, a method of controlling temperature before and after a stretching process, thereby reducing unevenness in orientation angle, Re, and Rth is described in Japanese Laid-Open Patent Publication Nos. 2006-051804 and 2005-254812.

However, in the method, the resultant stretched film becomes nonuniform in Re and Rth with time during storage. Thus, there is a demand for improving the method.

Further, the dimension of the film is changed by humidity, so that also the Re and Rth thereof are changed. An optical film, hardly changed in the Re and Rth by humidity, is disclosed in Japanese Laid-Open Patent Publication No. 2006-142800. The optical film is obtained by extruding a mixture of a cellulose ester and a plasticizer into a film using a melt casting method under a residence time of 5 minutes or less, while controlling the index of the film indicating precipitation of additives at 0.6% or less. Further, an optical film, which contains a cellulose ester having an acetyl group and a propionyl group to exhibit an Rth of 60 to 300 nm, is disclosed in Japanese Laid-Open Patent Publication No. 2001-188128. Furthermore, a method for producing a cellulose acylate film, comprising adding a plasticizer and using a touch roll, is disclosed in Japanese Laid-Open Patent Publication No. 2007-326359.

However, when these optical films are used in liquid crystal display panels, etc., display unevenness is often caused due to humidity change in the use environment.

### SUMMARY OF THE INVENTION

In view of solving the above conventional problems, an object of the present invention is to provide a cellulose acylate film, which exhibits only slight in-plane unevennesses (distributions) of Re and Rth due to environmental humidity change, slight dimensional change due to heat and humidity, and slight display unevenness due to environmental humidity change in a liquid crystal display device, and a method for producing the same.

The object of the present invention is achieved by the following aspects.

[1] A method for producing a cellulose acylate film, according to a first aspect of the present invention, comprising the step of transversely stretching a cellulose acylate film under conditions of [preheating temperature>stretching temperature] and [preheating zone length/stretching zone length=0.1 to 10], wherein the cellulose acylate film contains 1% to 25% by mass of a plasticizer and has a cellulose acylate composition satisfying the inequalities of 0≦X≦2.5 and 2.1≦X+Y≦3.0 (in which X is a substitution degree of acetyl group, and Y is a substitution degree of at least one group selected from propionyl, butyryl, and phthaloyl groups). The phthaloyl groups include phthaloyl, isophthaloyl and terephthaloyl. Phthaloyl is 1,2-benzenedicarbonyl residue obtained by removing two hydroxyl groups from a phthalic acid.

The film is preheated in a preheating zone, and the preheating zone length is the length of the preheating zone in the direction of transporting the film. The film is transversely stretched in a stretching zone, and the stretching zone length is the length of the stretching zone in the direction of transporting the film. Further, the preheating temperature is a temperature at which the film is preheated in the preheating zone, and the stretching temperature is a temperature at which the film is stretched in the stretching zone.

When a film is transversely stretched, the film is generally forced to shorten in the longitudinal direction perpendicular to the transverse stretching direction (neck-in phenomenon). Thus, in the film, portions in the vicinity of the transversely stretched portion are pulled to cause a stress. Though the both width direction ends of the film are fixed by chucks and thereby are hardly deformed by the stress, the width direction center of the film is easily deformed. Thus, a bow-like stress is generated by the neck-in to cause bowing, so that in some cases the Re and Rth of the film surface are made nonuniform, the orientation axes are distributed, and a strain remains in the film. Because of such surface nonuniformity, the local unevennesses (distributions) of Re and Rth changes due to humidity are increased. Further, due to the nonuniform stretching, a stress is locally increased, an in-plane strain is locally generated, and the film is locally dimensionally-changed by heat and humidity. The dimensional change by heat and humidity is represented by a maximum value, obtained by measuring the entire surface of the film. Even when only a part of the film exhibits a large dimensional change, a nonuniform image is shown in the part in a liquid crystal display device.

In contrast, in the present invention, by using the preheating temperature larger than the stretching temperature, the bowing and the residual strain (internal strain) are reduced in the stretching step. As a result, the in-plane anisotropy and nonuniformity of the film are reduced, the unevennesses of the Re and Rth changes due to humidity of the film surface are reduced, and the dimensional change of the film due to heat and humidity is reduced. By controlling the ratio of the preheating zone length to the stretching zone length to 0.1 to 10, the bowing and the internal strain are further reduced. When the preheating zone is too long, the neck-in cannot be sufficiently absorbed. When the preheating zone is too short, the film cannot be sufficiently preheated and softened, whereby the neck-in cannot be absorbed. The ratio of the preheating zone length to the stretching zone length is preferably 0.03 to 2, more preferably 0.1 to 1.5. The bowing and the internal strain can be reduced by using these stretching conditions. However, the local unevennesses (distributions) of the Re and Rth changes due to humidity, and the dimensional change due to heat and humidity cannot be sufficiently reduced under the conditions. Therefore, the plasticizer is added to the film in the present invention.

By adding 1% to 25% by mass of the plasticizer, the film can be softened, the local unevennesses (distributions) of the Re and Rth changes due to humidity can be more effectively reduced, and the local dimensional change due to heat and humidity can be more effectively reduced. The plasticizer shows such effects also in the stretching steps of [3] and [4] below. The mass ratio of the plasticizer is preferably 2% to 22% by mass, more preferably 3% to 20% by mass, for reducing the in-plane nonuniformity of the film due to stretching. The plasticizer used in the present invention is such an additive that the glass transition temperature can be lowered by 0.1° C. to 10° C. per 1% by mass of the plasticizer added (the mass ratio of the plasticizer to the cellulose acylate).

By controlling the substitution degree Y of the at least one group selected from propionyl, butyryl, and phthaloyl groups within the range of 0.1≦Y≦1.2, the distributions of the Re and Rth changes due to humidity and the dimensional change due to heat and humidity can be reduced, whereby the image unevenness of a liquid crystal display device using the cellulose acylate film can be reduced. This is because the propionyl group is more hydrophobic than the acetyl group. When Y is larger than the above range, the elasticity of the film is often reduced, and it is difficult to handle the film with a small thickness. Y is preferably 0.2 to 1.0, more preferably 0.3 to 0.9. The sum (X+Y) of the substitution degree X of acetyl group and the substitution degree Y of at least one group selected from propionyl, butyryl, and phthaloyl groups is preferably 2.15 to 2.96, more preferably 2.2 to 2.93.

The in-plane local distributions of the Re and Rth changes (ΔRe and ΔRth) due to humidity is preferably 30% or less, more preferably 20% or less, further preferably 10% or less. Further, the dimensional change due to heat and humidity is preferably 0.15% or less, more preferably 0.1% or less, further preferably 0.05% or less.

[2] A method according to [1], further comprising the step of, after the transversely stretching step, heat-fixing the film under conditions of [stretching temperature>heat-fixing temperature] and [heat-fixing zone length/stretching zone length=0.1 to 10].

The film is heat-fixed in a heat-fixing zone, and the heat-fixing zone length is the length of the heat-fixing zone in the direction of transporting the film. The heat-fixing temperature is a temperature at which the film is heat-fixed in the heat-fixing zone.

By using the stretching temperature larger than the heat-fixing temperature, the bowing and the residual strain are reduced in the stretching step. As a result, the in-plane anisotropy of the film is reduced, the in-plane local unevennesses of the Re and Rth changes due to humidity are reduced. By controlling the ratio of the heat-fixing zone length to the stretching zone length to 0.1 to 10, the bowing and the internal strain are further reduced. When the heat-fixing zone is too large, the Re and Rth generated by the stretching step are reduced (the orientation by the stretching step is relaxed). When the heat-fixing zone is too small, the stretching temperature cannot be lowered to the heat-fixing temperature, whereby the neck-in cannot be absorbed. The ratio of the heat-fixing zone length to the stretching zone length is preferably 0.2 to 5, more preferably 0.3 to 2.

[3] A method for producing a cellulose acylate film, according to a second aspect of the present invention, comprising the step of longitudinally stretching a cellulose acylate film at a length/width ratio (L/W) of more than 2 and at most 50 using at least two pairs of nip rolls at a nip pressure of 0.5 to 10 MPa, wherein the cellulose acylate film contains 1% to 25% by mass of a plasticizer and has a cellulose acylate composition satisfying the inequality of 2.1≦X+Y≦3.0 (in which X is a substitution degree of acetyl group, and Y is a substitution degree of at least one group selected from propionyl, butyryl, and phthaloyl groups).

When the length/width ratio (L/W) is a large value of more than 2 and at most 50, the film is slowly stretched over long distance and time, so that the stretching nonuniformity in the width direction can be eliminated, and the Re and Rth unevennesses are hardly generated. Therefore, the in-plane anisotropy of the film can be reduced, and the in-plane local unevennesses of the Re and Rth changes due to humidity, and the dimensional change due to heat and humidity can be reduced.

When the nip pressure is less than the above range, the film is slipped in the stretching step, causing the stretching nonuniformity, whereby the in-plane local unevennesses of the Re and Rth changes due to humidity, and the dimensional change due to heat and humidity are increased. When the nip pressure is more than the above range, the film is strongly pressed, whereby disadvantageously the pressure is likely to be locally distributed, causing the stretching nonuniformity, and the film is likely to be scratched.

The plasticizer acts as a lubricant between molecules to disperse a nonuniform stress, thereby reducing the stretching nonuniformity, in the stretching step. However, when the mass ratio of the plasticizer is more than 25% by mass, the plasticizer is often deposited on the film surface and slips the nip rolls disadvantageously.

[4] A method for producing a cellulose acylate film, according to a third aspect of the present invention, comprising the step of longitudinally stretching a cellulose acylate film at a length/width ratio (L/W) of more than 0.01 and less than 0.3 using at least two pairs of nip rolls at a nip pressure of 0.5 to 10 MPa, wherein the cellulose acylate film contains 1% to 25% by mass of a plasticizer and has a cellulose acylate composition satisfying the inequalities of 0≦X≦2.5 and 2.1≦X+Y≦3.0 (in which X is a substitution degree of acetyl group, and Y is a substitution degree of at least one group selected from propionyl, butyryl, and phthaloyl groups).

When the length/width ratio (L/W) is within the above range, the neck-in is reduced in the stretching step. The neck-in is caused in a case where the stretching is more accelerated in the both ends of the film than in the center. When the L/W is small, the stretching can be completed before the development of the neck-in, reducing the stretching nonuniformity. When the L/W is less than the above range, the stretching distance is too short to sufficiently stretch the film.

In the second and third aspects of the present invention, the Rth can be small under the L/W of more than 2 and at most 50 (a long-span stretching condition), and the Rth can be large under the L/W of 0.01 to 0.3 (a short-span stretching condition). In the present invention, though the film may be stretched under the long-span stretching condition, the short-span stretching condition, or the intermediate thereof (an intermediate stretching condition using the L/W of more than 0.3 and at most 2), the long-span stretching condition and the short-span stretching condition are preferred from the viewpoint of reducing the in-plane local unevennesses of the Re and Rth changes due to humidity, and the dimensional change due to heat and humidity. It is further preferred that the short-span stretching condition or the long-span stretching condition is selected to obtain a high Rth or a low Rth.

[5] A method according to [3] or [4], wherein at least one pair of the nip rolls has a peripheral speed difference of 0.01% to 1%.

When the peripheral speed difference is within the above range, the film can be slightly vibrated in the stretching step. Adhesion between the film and the nip rolls can be prevented by the vibration. In a case where the film adheres to the nip rolls, the film is stuck to and peeled from the nip rolls repeatedly, so that the stretching nonuniformity is increased each time, and the in-plane local unevennesses of the Re and Rth changes due to humidity and the dimensional change due to heat and humidity are increased. When the peripheral speed difference is less than the above range, this effect is insufficient. When the peripheral speed difference is more than the above range, the stretching nonuniformity is increased adversely. The peripheral speed difference is preferably 0.03% to 0.6%, more preferably 0.05% to 0.4%. It should be noted that the peripheral speed difference means a difference in peripheral speed between two rolls for nipping the film. The peripheral speed difference is obtained on percentage from average peripheral speeds of the nip rolls. The average peripheral speed of each roll is obtained by measuring the peripheral speed of the roll for 1 minute, and by calculating the average of the measured maximum and minimum speeds.

[6] A method for producing a cellulose acylate film, according to a fourth aspect of the present invention, comprising the transversely stretching step of [1] or [2] and the longitudinally stretching step of any one of [3] to [5].

[7] A method according to any one of [1] to [6], further comprising the step of, after the stretching step, subjecting the film to a relaxation treatment while transporting the film at a temperature of Tg−20° C. to Tg+20° C. (in which Tg is the glass transition temperature of the film) at a tension of 1 to 20 kg/cm².

By thermally treating the film while transporting under the conditions, the internal strain generated in the stretching step can be relaxed, and the in-plane unevennesses of the Re and Rth changes due to humidity can be reduced. The temperature of the relaxation treatment is preferably Tg−15° C. to Tg+10° C., and the tension is preferably 1 to 16 kg/cm², more preferably 2 to 12 kg/cm².

[8] A method according to any one of [1] to [7], wherein the film has a residual solvent content of 1% by mass or less in the steps of preheating, stretching, heat-fixing, and relaxation treatment.

When the film contains a residual solvent, the film is stressed by drying shrinkage as well as by the stretching. As a result, the stresses are accumulated in the film, and as such, increase the in-plane nonuniformity of the film.

[9] A method according to any one of [1] to [8], wherein the cellulose acylate film is prepared by a melt casting method containing an extrusion step using a screw, the gap between a flight (hill) and a barrel in the screw being 0.1 to 10 mm.

By controlling the gap within the above range, kneading failure can be prevented. As a result, the formed film has a more uniform in-plane structure, and the in-plane uniformity can be maintained in the stretching step. When the kneading failure is caused, a weak portion and a strong portion are formed on the surface of the film, and the stretching stress is accumulated in the weak portion to increasing the stretching nonuniformity. The gap is preferably 0.2 to 8 mm, more preferably 0.3 to 5 mm.

[10] A method according to [9], wherein, in the melt casting method, a melt is extruded from a die, nipped between a first cooling roll and an elastically deformable touch roll, and transported through a second cooling roll having a temperature lower than that of the first cooling roll by 1° C. to 29° C., to form a film.

By using the touch roll, the melt is brought into uniform contact with the cooling roll and cooled, so that a nonuniform residual strain hardly remains in the formed film, and the film has in-plane uniformity. Thus, the unevennesses of the Re and Rth, and the in-plane unevennesses of the Re and Rth changes (ΔRe and ΔRth) due to humidity can be reduced.

The melt is transported through the second cooling roll after being pressed between the first cooling roll and the touch roll. The temperature of the second cooling roll is preferably lower than that of the first cooling roll, and the temperature difference between the cooling rolls is preferably 1° C. to 29° C., more preferably 2° C. to 25° C., further preferably 2° C. to 20° C. When the temperature of the second cooling roll is lower than the temperature range above, a strain is generated due to rapid cooling, and then increased due to the stretching in the film, so that the unevennesses of the Re and Rth, and the Re and Rth changes due to humidity are often increased disadvantageously. When the temperature of the second cooling roll is higher than the temperature range above, the melt is air-cooled during the transport from the first cooling roll to the second cooling roll, and then reheated by the second cooling roll. In a case where the film is once cooled and then reheated, a strain is easily generated in the film, so that the unevennesses of the Re and Rth, and the in-plane unevennesses of the Re and Rth changes due to humidity are disadvantageously increased. The temperature of the first cooling roll is preferably Tg−30° C. or higher, more preferably Tg−1° C. to Tg−25° C., further preferably Tg−2° C. to Tg−20° C., in which Tg used herein is the glass transition temperature of the melt. In the melt film forming method, three or more cooling rolls may be used. The number of the cooling rolls is preferably 2 to 8, more preferably 3 to 5.

[11] A method according to any one of [1] to [8], wherein the cellulose acylate film is prepared by a solution cast film forming method using a band having a thickness of 0.5 to 2 mm.

The thickness of the flow casting band is preferably 0.5 to 2 mm, more preferably 1.0 to 1.6 mm. When the thickness is less than 0.5 mm, a surface of the band is often wrinkled under a tension to the band, so that the flatness of the band is deteriorated, increasing the stretching nonuniformity. On the other hand, when the thickness is more than 2 mm, a remarkably high tension is required to drive the band while maintaining the flatness, so that the durability of the band is reduced in some cases.

[12] A method according to any one of [1] to [1,1], wherein the cellulose acylate film has a thickness of 20 to 100 μm after the stretching step.

When the thickness of the stretched film is too large, the mechanical strength of the film is excessively increased. Thus, in a case of attaching the film to a polarizing plate or the like, the resultant plate is warped due to a humidity change like a bimetal, tending to generate a residual strain. This strain increases the liquid crystal display nonuniformity. The thickness is preferably 25 to 85 μm, more preferably 30 to 60 μm.

[13] A cellulose acylate film according to a fifth aspect of the present invention, which exhibits a dimensional change due to heat and humidity (40° C., relative humidity 95%, 1 day) of 0.15% or less, and in-plane distributions of Re and Rth changes (ΔRe and ΔRth) due to humidity of 30% or less.

The cellulose acylate film according to the fifth aspect of the present invention can be produced by the above-mentioned producing method of the present invention.

Further, the cellulose acylate film of the present invention can be used for a polarizing plate, an optical compensatory film for a liquid crystal display panel, or an antireflection film.

Furthermore, at least one of the cellulose acylate film, the polarizing plate, the optical compensatory film, and the antireflection film according to the present invention can be used in a liquid crystal display device.

According to the present invention, there are provided the cellulose acylate film, which exhibits only a slight unevenness (nonuniformity) of retardation change due to environmental humidity, and the producing method thereof. Further, in the present invention, there are provided the polarizing plate, the optical compensatory film for liquid crystal display panel, and the antireflection film using the above effective cellulose acylate film, and the liquid crystal display device containing them.

### BRIEF DESCRIPTION OF THE DRAWINGS

FIG. 1 is a schematic structural view showing a film producing apparatus for producing a cellulose acylate film according to an embodiment of the present invention using a melt film forming method;

FIG. 2 is a perspective explanatory view showing a longitudinal stretching zone in the film producing apparatus of FIG. 1;

FIG. 3 is a schematic structural view showing a film producing apparatus according to a modification embodiment of the present invention;

FIG. 4 is a perspective explanatory view showing a longitudinal stretching zone in the film producing apparatus of FIG. 3;

FIG. 5 is a schematic structural view showing a liquid crystal display device using a cellulose acylate film according to an embodiment of the present invention; and

FIG. 6 is an explanatory view showing a bowing phenomenon in conventional methods.

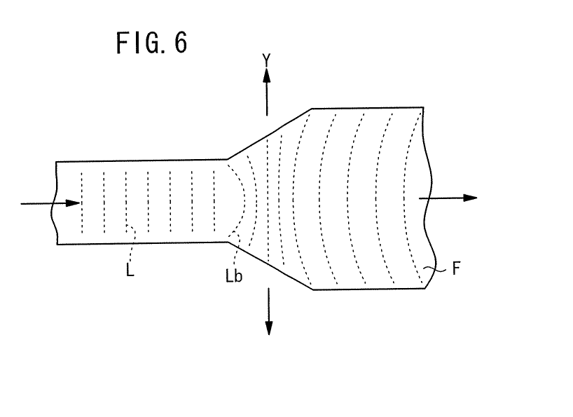

### DESCRIPTION OF THE PREFERRED EMBODIMENTS

The present invention will be described in detail below sequentially. It should be noted that, in the present invention, a numeric range of “A to B” includes both the numeric values A and B as the lower limit and upper limit values.

In this specification, Re(λ) and Rth(λ) represent an in-plane retardation and a retardation in the thickness direction at a wavelength of λ nm, respectively. The Re(λ) is measured by means of KOBRA 21ADH or WR manufactured by Oji Scientific Instruments, by applying a λ-nm wavelength light in the normal line direction of the film. The wavelength of k nm may be selected by manually changing a wavelength selection filter, or by converting a measured value using a program, etc.

In a case where the film to be measured is a uniaxial or biaxial refractive index ellipsoid, the Rth(λ) is calculated in the following manner.

The Rth(λ) is calculated by KOBRA 21ADH or WR based on six measured Re(λ) values, an assumed value of the average refractive index, and an input film thickness. The retardation Re(λ) values are measured such that a λ-nm wavelength light is applied to the film from six directions tilted at 0° to 50° with 10° interval to the film normal line, using an in-plane slow axis (detected by KOBRA 21ADH or WR) as a tilt axis (rotation axis). When the film has no slow axis, an optional in-plane direction is used as the rotation axis.

When a retardation value measured using the in-plane slow axis as the rotation axis is zero at a particular tilt angle to the normal line, the positive sign of a retardation value at a tilt angle larger than the particular tilt angle is converted to the negative sign, and then the negative retardation value is used in the calculation by KOBRA 21ADH or WR.

The Rth may be calculated by the following equalities (1) and (2) based on an assumed value of the average refractive index, an input thickness value, and two retardation values measured in two tilt directions, using the slow axis as the tilt axis (the rotation axis). When the film has no slow axis, an optional in-plane direction is used as the rotation axis.

$$Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) )} \qquad Equality ( 1 )$$

In the equality (1), Re(θ) represents a retardation value in a direction tilted at an angle θ to the film normal line, nx represents an in-plane refractive index in the slow axis direction, ny represents an in-plane refractive index in a direction perpendicular to the slow axis direction, nz represents a refractive index in a direction perpendicular to both the directions, and d represents a film thickness.

Rth=((nx+ny)/2−nz)×d Equality (2)

In a case where the film to be measured is not a uniaxial or biaxial refractive index ellipsoid, and thus has no so-called optic axes, the Rth(λ) is calculated in the following manner.

The Rth(λ) is calculated by KOBRA 21ADH or WR based on eleven measured Re(λ) values, an assumed value of the average refractive index, and an input film thickness value. The retardation Re(λ) values are measured such that a λ-nm wavelength light is applied to the film from eleven directions tilted at −50° to +50° with 10° interval to the film normal line, using an in-plane slow axis (detected by KOBRA 21ADH or WR) as a tilt axis (rotation axis).

In the above measurements, the assumed values of the average refractive indices may be those described in Polymer Handbook (JOHN WILEY & SONS, INC.) and catalogs of various optical films. Unknown average refractive indices may be obtained by measurement using an Abbe refractometer. The average refractive indices of major optical film materials are as follows: cellulose acylate (1.48), cycloolefin polymer (1.52), polycarbonate (1.59), polymethyl methacrylate (1.49), polystyrene (1.59). The above values of nx, ny, and nz are calculated by KOBRA 21ADH or WR from the input assumed average refractive index and film thickness value. Nz is calculated from thus obtained nx, ny, and nz by Nz=(nx−nz)/(nx−ny).

### [Cellulose Acylate]

The cellulose acylate film according to the present invention preferably comprises at least one cellulose acylate selected from the group consisting of cellulose acetates, cellulose propionates, cellulose butyrates, cellulose acetate propionates, cellulose acetate butyrates, cellulose acetate phthalates, and cellulose phthalates.

Among them, more preferred cellulose acylates include cellulose acetates, cellulose propionates, cellulose butyrates, cellulose acetate propionates, and cellulose acetate butyrates.

It is further preferred that the cellulose acylate film comprises a cellulose resin containing the cellulose acylate preferably such as the cellulose acetate propionate or cellulose acetate butyrate, and the cellulose acylate contains a substituent of an acyl group having 2 to 4 carbon atoms and satisfies both the following inequalities (I) and (II), in which X is a substitution degree of acetyl group, and Y is a substitution degree of propionyl or butyryl group.

0≦X≦2.5 Inequality (I)

2.1≦X+Y≦3.0 Inequality (II)

The cellulose acetate propionate is particularly preferred among the above cellulose acylates, and the substitution degrees X and Y particularly preferably satisfy 1.9≦X≦2.5 and 0.1≦Y≦1.2. A hydroxyl group in the cellulose acylate, not substituted with the acyl group, is generally present in the state of unmodified hydroxyl group.

The cellulose acylate can be synthesized by using an acylating agent such as an acid anhydride or an acid chloride. In the synthesis using the acid anhydride as the acylating agent, a solvent such as an organic acid (e.g. acetic acid) or methylene chloride is used as a reaction solvent, and an acidic substance such as sulfuric acid is used as a catalyst. In the synthesis using the acid chloride as the acylating agent, a basic compound is used as a catalyst. In a most industrially common synthesis method, the cellulose acylate is synthesized by esterifying a cellulose with an organic acid agent corresponding to the acetyl group, propionyl group, or the like, which contains an organic acid (e.g. acetic acid, propionic acid) or an acid anhydride (e.g. acetic anhydride, propionic anhydride). The amount of each acylating agent such as an acetylating agent or a propionylating agent is controlled such that the synthesized ester satisfies the above substitution degree conditions. The amount of the reaction solvent is preferably 100% to 1000% by mass, per 100% by mass of the cellulose. The amount of the acidic catalyst is preferably 0.1% to 20% by mass, per 100% by mass of the cellulose. The reaction temperature is preferably 10° C. to 120° C. After the acylation reaction, the product may be subjected to hydrolysis (saponification) to control the substitution degree, if necessary. After the reaction, the reaction mixture (a cellulose acylate dope) may be purified by a known method such as a precipitation method, washed, and dried, to obtain the cellulose acylate.

For example, the cellulose acylate may be synthesized as follows. 907 g of acetic acid and 223 g of propionic acid are added to 299 g of a cellulose, and mixed at 54° C. for 30 minutes. The mixture is cooled, and thereto are added 318 g of acetic anhydride, 813 g of propionic anhydride, 10.6 g of sulfuric acid, and 6.3 g of propionic acid, cooled at about 20° C., to esterify the cellulose. The esterification is carried out while controlling the reaction temperature at 40° C. or lower. After the esterification is carried out for 150 minutes, a mixture solution of 295 g of acetic acid and 98.5 g of water is added as a reaction terminator to the reaction mixture over 22 minutes to hydrolyze the excess anhydrides. The temperature of the reaction liquid is kept at 62° C., and 886 g of acetic acid and 295 g of water are added to the reaction liquid. One hour after the addition, an aqueous solution containing 18.0 g of magnesium acetate is added to the reaction liquid, to neutralize the sulfuric acid in the reaction system. The resultant cellulose acetate propionate has an acetyl substitution degree of 2.0, a propionyl substitution degree of 0.8, and a number average molecular weight of about 100,000.

The cellulose acylate film of the present invention may comprise a cellulose acylate synthesized from a cotton linter, a cellulose acylate synthesized from a wood pulp, or a mixture thereof. It is preferred from the viewpoint of productivity that a large amount of a cellulose triacetate synthesized from the cotton linter is used for the film, because the cellulose triacetate is excellent in peeling from a belt, a drum, or the like. The peeling property is significantly improved when the content of the cellulose triacetate synthesized from the cotton linter is 60% or more. The content of the cellulose triacetate is preferably 60% or more, more preferably 85% or more. It is further preferred that the cellulose triacetate is used singly.

The film formation method (the melt film forming method or the solution cast film forming method) and the stretching method of the present invention will be described below.

The stretching method of the present invention can be used for a film formed by the melt or solution cast film forming method, and is preferably used for a film having a residual solvent content of 1% by mass or less.

### 1. Melt Film Forming Method

### (1) Material

The ratio of the weight average molecular weight Mw/the number average molecular weight Mn of the cellulose acylate with the above composition is preferably 1.5 to 5.5. The ratio is more preferably 2.0 to 5.0, further preferably 2.5 to 5.0, still further preferably 3.0 to 5.0. The number average molecular weight of the cellulose acylate is preferably 70,000 to 300,000, more preferably 90,000 to 200,000.

The following additives are preferably added to the cellulose acylate.

### [Plasticizer]

Preferred examples of the plasticizers used in the present invention include phosphate ester derivatives and carboxylate ester derivatives. The preferred examples further include polymers of an ethylenic unsaturated monomer having a weight average molecular weight of 500 to 10000, as described in Japanese Laid-Open Patent Publication No. 2003-12859; and acrylic polymers, which may have a side chain containing an aromatic ring or a cyclohexyl group.

Examples of the plasticizers include phosphate ester plasticizers, ethylene glycol ester plasticizers, glycerin ester plasticizers, diglycerin ester plasticizers (fatty ester plasticizers), polyalcohol ester plasticizers, dicarboxylate ester plasticizers, polycarboxylate ester plasticizers, and polymer plasticizers. Among them, the polyalcohol ester plasticizers, dicarboxylate ester plasticizers, and polycarboxylate ester plasticizers are preferred. The plasticizer may be liquid or solid, and is preferably colorless in view of composition limitations. The plasticizer is preferably stable at a higher temperature, and the decomposition initiation temperature thereof is preferably 150° C. or higher, more preferably 200° C. or higher. The amount of the plasticizer is controlled such that the optical properties and mechanical properties of the film are not adversely affected by the plasticizer.

The plasticizer used in the present invention will be described in more detail below. The plasticizer is not limited to specific examples to be hereinafter described.

Specific examples of the phosphate ester plasticizers include alkyl phosphate esters such as triacetyl phosphate and tributyl phosphate; cycloalkyl phosphate esters such as tricyclopentyl phosphate and cyclohexyl phosphate; and aryl phosphate esters such as triphenyl phosphate, tricresyl phosphate, cresylphenyl phosphate, octyldiphenyl phosphate, diphenylbiphenyl phosphate, trioctyl phosphate, tributyl phosphate, trinaphthyl phosphate, trixylyl phosphate, and tris ortho-biphenyl phosphate. The phosphate ester plasticizer may contain the same or different substituents, and the substituents may be further substituted. The alkyl, cycloalkyl, and aryl groups may be used in combination in the phosphate ester plasticizer, and the substituents may be covalently bonded to each other.

The specific examples of the phosphate ester plasticizers further include alkylene bis(dialkyl phosphate)s such as ethylene bis(dimethyl phosphate) and butylene bis(diethyl phosphate); alkylene bis(diaryl phosphate)s such as ethylene bis(diphenyl phosphate) and propylene bis(dinaphthyl phosphate); arylene bis(dialkyl phosphate)s such as phenylene bis(dibutyl phosphate) and biphenylene bis(dioctyl phosphate); and arylene bis(diaryl phosphate)s such as phenylene bis(diphenyl phosphate) and naphthylene bis(ditoluoyl phosphate). The phosphate ester plasticizer may contain the same or different substituents, and the substituents may be further substituted. The alkyl, cycloalkyl, and aryl groups may be used in combination in the phosphate ester plasticizer, and the substituents may be covalently bonded to each other.

Further, the phosphate ester moiety may be used as a part or a regularly distributed pendant group of a polymer, and may be introduced into a molecule of an additive such as an antioxidant, an acid scavenger, or an ultraviolet absorber. The aryl phosphate esters and the arylene bis(diaryl phosphate)s are preferred among the above compounds, and specifically the phosphate ester plasticizer is preferably triphenyl phosphate or phenylene bis(diphenyl phosphate).

Specific examples of the ethylene glycol ester plasticizers include ethylene glycol alkyl ester plasticizers such as ethylene glycol diacetate and ethylene glycol dibutyrate; ethylene glycol cycloalkyl ester plasticizers such as ethylene glycol dicyclopropyl carboxylate and ethylene glycol dicyclohexyl carboxylate; and ethylene glycol aryl ester plasticizers such as ethylene glycol dibenzoate and ethylene glycol di-4-methyl benzoate. The ethylene glycol ester plasticizer may contain the same or different alkylate, cycloalkylate, or arylate groups, and the substituents may be further substituted. The alkylate, cycloalkylate, and arylate groups may be used in combination in the ethylene glycol ester plasticizer, and the substituents may be covalently bonded to each other. Further, the ethylene glycol group may be substituted, and the ethylene glycol ester moiety may be used as a part or a regularly distributed pendant group of a polymer, and may be introduced into a molecule of an additive such as an antioxidant, an acid scavenger, or an ultraviolet absorber.

Specific examples of the glycerin ester plasticizers include glycerin alkyl esters such as triacetin, tributyrin, glycerin diacetate caprylate, and glycerin oleate propionate; glycerin cycloalkyl esters such as glycerin tricyclopropyl carboxylate and glycerin tricyclohexyl carboxylate; glycerin aryl esters such as glycerin tribenzoate and glycerin 4-methylbenzoate; diglycerin alkyl esters such as diglycerin tetra acetylate, diglycerin tetrapropionate, diglycerin acetate tricaprylate, and diglycerin tetra laurate; diglycerin cycloalkyl esters such as diglycerin tetracyclobutylcarboxylate and diglycerin tetracyclopentylcarboxylate; and diglycerin aryl esters such as diglycerin tetrabenzoate and diglycerin 3-methylbenzoate. The glycerin ester plasticizer may contain the same or different alkylate, cycloalkyl carboxylate, or arylate groups, and the substituents may be further substituted. The alkylate, cycloalkyl carboxylate, and arylate groups may be used in combination in the glycerin ester plasticizer, and the substituents may be covalently bonded to each other. Further, the glycerin or diglycerin group may be substituted, and the glycerin or diglycerin ester moiety may be used as a part or a regularly distributed pendant group of a polymer, and may be introduced into a molecule of an additive such as an antioxidant, an acid scavenger, or an ultraviolet absorber.

Specific examples of the polyalcohol ester plasticizers include those described in Japanese Laid-Open Patent Publication No. 2003-12823, Paragraph [0030] to [0033]. The polyalcohol ester plasticizer may contain the same or different alkylate, cycloalkyl carboxylate, or arylate groups, and the substituents may be further substituted. The alkylate, cycloalkyl carboxylate, and arylate groups may be used in combination in the polyalcohol ester plasticizer, and the substituents may be covalently bonded to each other. Further, the polyalcohol group may be substituted, and the polyalcohol moiety may be used as a part or a regularly distributed pendant group of a polymer, and may be introduced into a molecule of an additive such as an antioxidant, an acid scavenger, or an ultraviolet absorber.

Specific examples of the dicarboxylate ester plasticizers include alkyl alkyldicarboxylate plasticizers such as didodecyl malonate (C1), dioctyl adipate (C4), and dibutyl sebacate (C8); cycloalkyl alkyldicarboxylate plasticizers such as dicyclopentyl succinate and dicyclohexyl adipate; aryl alkyldicarboxylate plasticizers such as diphenyl succinate and di-4-methylphenyl glutarate; alkyl cycloalkyldicarboxylate plasticizers such as dihexyl 1,4-cyclohexanedicarboxylate and didecyl bicyclo[2.2.1]heptane-2,3-dicarboxylate; cycloalkyl cycloalkyldicarboxylate plasticizers such as dicyclohexyl 1,2-cyclobutanedicarboxylate and dicyclopropyl 1,2-cyclohexyldicarboxylate; aryl cycloalkyldicarboxylate plasticizers such as diphenyl 1,1-cyclopropyldicarboxylate and di-2-naphthyl 1,4-cyclohexanedicarboxylate; alkyl aryldicarboxylate plasticizers such as diethyl phthalate, dimethyl phthalate, dioctyl phthalate, dibutyl phthalate, and di-2-ethylhexyl phthalate; cycloalkyl aryldicarboxylate plasticizers such as dicyclopropyl phthalate and dicyclohexyl phthalate; and aryl aryldicarboxylate plasticizers such as diphenyl phthalate and di-4-methylphenyl phthalate. The dicarboxylate ester plasticizer may be a mono-substituted ester and may contain the same or different alkoxy or cycloalkoxy groups, and the substituents may be further substituted. The alkyl and cycloalkyl groups may be used in combination in the dicarboxylate ester plasticizer, and the substituents may be covalently bonded to each other. Further, the aromatic ring of the phthalic acid group may be substituted, and the dicarboxylate ester plasticizer may be an oligomer such as a dimer, a trimer, or a tetramer. The phthalic ester moiety may be used as a part or a regularly distributed pendant group of a polymer, and may be introduced into a molecule of an additive such as an antioxidant, an acid scavenger, or an ultraviolet absorber.

Specific examples of the polycarboxylate ester plasticizers include alkyl alkylpolycarboxylate plasticizers such as tridodecyl tricarbarate and tributyl meso-butane-1,2,3,4-tetracarboxylate; cycloalkyl alkylpolycarboxylate plasticizers such as tricyclohexyl tricarbarate and tricyclopropyl 2-hydroxy-1,2,3-propanetricarboxylate; aryl alkylpolycarboxylate plasticizers such as triphenyl 2-hydroxy-1,2,3-propanetricarboxylate and tetra-3-methylphenyl tetrahydrofuran-2,3,4,5-tetracarboxylate; alkyl cycloalkylpolycarboxylate plasticizers such as tetrahexyl 1,2,3,4-cyclobutanetetracarboxylate and tetrabutyl 1,2,3,4-cyclopentanetetracarboxylate; cycloalkyl cycloalkylpolycarboxylate plasticizers such as tetracyclopropyl 1,2,3,4-cyclobutanetetracarboxylate and tricyclohexyl 1,3,5-cyclohexyltricarboxylate; aryl cycloalkylpolycarboxylate plasticizers such as triphenyl 1,3,5-cyclohexyltricarboxylate and hexa-4-methylphenyl 1,2,3,4,5,6-cyclohexylhexacarboxylate; alkyl arylpolycarboxylate plasticizers such as tridodecyl benzene-1,2,4-tricarboxylate and tetraoctyl benzene-1,2,4,5-tetracarboxylate; cycloalkyl arylpolycarboxylate plasticizers such as tricyclopentyl benzene-1,3,5-tricarboxylate and tetracyclohexyl benzene-1,2,3,5-tetracarboxylate; and aryl arylpolycarboxylate plasticizers such as triphenyl benzene-1,3,5-tetracarboxylate and hexa-4-methylphenyl benzene-1,2,3,4,5,6-hexacarboxylate. The polycarboxylate ester plasticizer may be a mono-substituted ester and may contain the same or different alkoxy or cycloalkoxy groups, and the substituents may be further substituted. The alkyl and cycloalkyl groups may be used in combination in the polycarboxylate ester plasticizer, and the substituents may be covalently bonded to each other. Further, the aromatic ring of the phthalic acid group may be substituted, and the polycarboxylate ester plasticizer may be an oligomer such as a dimer, a trimer, or a tetramer. The phthalic ester moiety may be used as a part or a regularly distributed pendant group of a polymer, and may be introduced into a molecule of an additive such as an antioxidant, an acid scavenger, or an ultraviolet absorber.

Specific examples of the polymer plasticizers include aliphatic hydrocarbon polymers; alicyclic hydrocarbon polymers; acrylic polymers such as polyethyl acrylates and polymethyl methacrylates; vinyl polymers such as polyvinyl isobutyl ethers and poly-N-vinyl pyrrolidones; styrene polymers such as polystyrenes and poly-4-hydroxystyrenes; polyesters such as polybutylene succinates, polyethylene terephthalates, and polyethylene naphthalates; polyethers such as polyethylene oxides and polypropylene oxides; polyamides; polyurethanes; and polyureas. The number average molecular weight of the polymer is preferably about 1,000 to 500,000, particularly preferably 5,000 to 200,000. When the number average molecular weight is 1,000 or less, the polymer has a problem in volatility. When the number average molecular weight is more than 500,000, the plasticizing property of the polymer is reduced, thereby adversely affecting the mechanical properties of the cellulose acylate composition. The polymer plasticizer may be a homopolymer composed of one repeating unit or a copolymer composed of a plurality of repeating units. Further, the above polymers may be used in combination of two or more.

Further, a compound represented by the following general formula (1) may be used as the plasticizer.

A-(X—B)ₙ General formula (1)

In the general formula (1), A represents an alkyl group, X represents a divalent linking group selected from the group consisting of —NHCO—, —NHSO₂—, —O—, and —SO₂—, B represents an aromatic group, n represents 3 or 4, and a plurality of (X—B)'s may be the same or different groups.

More specifically, the compound may be represented by the following general formula (2), (3), or (4).

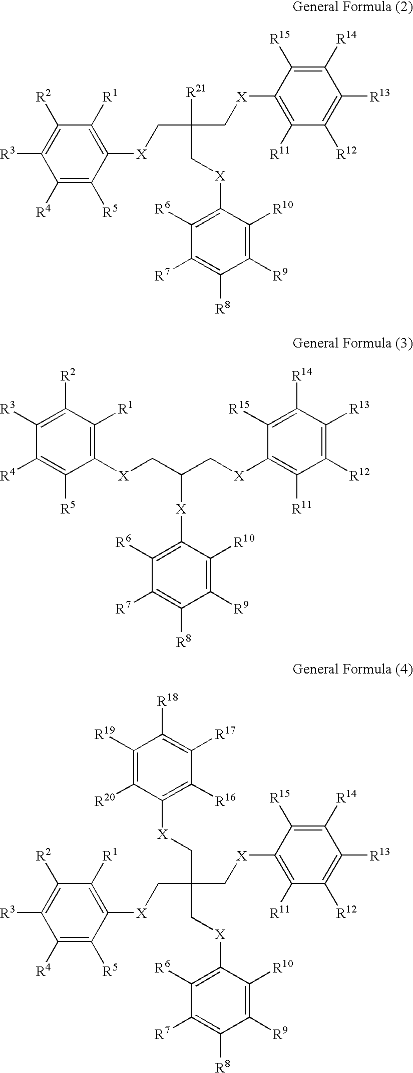

In the general formulae (2) to (4), X represents a divalent linking group selected from the group consisting of —NHCO—, —NHSO₂—, —O—, and —SO₂—, R¹ to R²⁰ independently represent a hydrogen atom, a cycloalkyl group, an aralkyl group, an alkoxy group, a cycloalkoxy group, an aryloxy group, an aralkyloxy group, an acyl group, a carbonyloxy group, an oxycarbonyl group, or an oxycarbonyloxy group, and the groups may further have a substituent. R represents an alkyl group.

Further specific examples of the compounds include those illustrated in Chemical Formulae 2 to 44 of Japanese Laid-Open Patent Publication No. 2007-326359. The compound is preferably a compound 3-1, 3-6, or 4-1 illustrated in the Chemical Formula 2, further preferably a compound 2-1 illustrated in the Chemical Formula 2.

It is preferred that the plasticizer does not generate a volatile component in thermal melting steps. Specific examples of such plasticizers include nonvolatile phosphate esters described in Japanese Laid-Open Patent Publication No. 6-501040 (PCT Application). For example, arylene-bis(diarylphosphate) esters and trimethylolpropane tribenzoate are preferred as the plasticizer among the above example compounds, though not restrictive. In a case where the volatile component can be generated due to heat decomposition of the plasticizer, the heat decomposition temperature Td (1.0) of the plasticizer is defined as a temperature at which the mass of the plasticizer is reduced by 1.0% by mass, and the heat decomposition temperature Td (1.0) of the plasticizer has to be higher than the melting temperature of the material for the film. This is because the amount of the plasticizer added to the cellulose acylate is larger than those of other additives in view of the above object, and the quality of the resultant film can be largely adversely affected by the volatile component. The heat decomposition temperature Td (1.0) may be measured by a commercially available, differential thermogravimetric analysis (TG-DTA) apparatus.

### [Other Additives]

In the present invention, an additive may be added to the cellulose acylate before or in the step of thermally melting the cellulose acylate polymer.

Examples of the additives include, in addition to the above plasticizers, degradation inhibitors (such as antioxidants, acid scavengers, light stabilizers, peroxide decomposers, radical scavengers, and metal deactivators), ultraviolet absorbers, and matting agents. Further, also the other additives having the above-mentioned functions may be used in the present invention.

The additive may be used for preventing the deterioration such as coloration or molecular weight reduction and the generation of a volatile component due to the decomposition of the film forming material by a known or unknown reaction, or for improving a function such as moisture permeability or lubricating property. For example, the oxidation of the film forming material may be prevented, an acid generated by the decomposition of the material may be scavenged, and a decomposition reaction with a radical generated due to light or heat may be inhibited or stopped, by using the additive.

In some cases, when the film forming material is thermally melted, a decomposition reaction is accelerated, causing the coloration or the molecular weight reduction, and the strength of the material is deteriorated by the reaction. Further, an undesired volatile component may be generated by the decomposition reaction of the film forming material.

It is preferred that the additive is used in the step of thermally melting the film forming material from the viewpoint of preventing the strength reduction due to the deterioration or decomposition of the material, thereby maintaining the original strength of the material, to produce the cellulose acylate film of the present invention.

Further, it is preferred that the additive is used in thermally melting step from the viewpoint of preventing the generation of a visually colored component, or reducing or eliminating adverse effects on the properties such as transmittance and haze of the cellulose acylate film by a volatile component in the film.

When the cellulose acylate film of the present invention has a haze of more than 2%, a displayed image of a liquid crystal display device is adversely affected by the cellulose acylate film. The haze is preferably less than 1%, more preferably less than 0.5%. The yellow index (YI) of the cellulose acylate film, which can be used as a measure of coloration, is preferably 3.0 or less, more preferably 1.0 or less.

Further, the cellulose acylate film of the present invention preferably has a transmittance of 85% or more.

In the production of the cellulose acylate film of the present invention, the strength deterioration of the film forming material can be prevented, and the original strength of the material can be maintained in the step of generating the retardation. When the film forming material is significantly deteriorated and made brittle, the film may be easily broken in the stretching step, failing to control the retardation.

The film forming material may be deteriorated by oxygen or water in air in the storage or the film forming process. Thus, it is preferred that a technology of reducing the humidity and the oxygen concentration of the air is used in combination with the additive in view of the object of the present invention. The reduction may be achieved by a known method. For example, the material may be handled under an inert gas such as nitrogen or argon gas, under a reduced or vacuum pressure, or under a closed environment. At least one of the known methods may be used in combination with the stabilizer to be described later. It is preferred in view of the object of the present invention that the deterioration of the film forming material is prevented by reducing the contact frequency of the material and the oxygen in the air.

Further, it is important to use the additive in the film forming material also from the viewpoint of using the cellulose acylate film of the present invention as a polarizing plate protecting film, thereby improving the temporal storage stability of a polarizing plate and a polarizer thereof.

In a liquid crystal display device using a polarizing plate according to the present invention, by using the additive in the cellulose acylate film of the present invention, the above-mentioned degradation and deterioration can be prevented, so that the temporal storage stability of the cellulose acylate film can be improved, and the displayed image quality of the liquid crystal display device can be improved for a long period by the optical compensatory property.

The additives will be described in more detail below.

### (Antioxidant)

Examples of the antioxidants include phenol antioxidants, phosphorus antioxidants, sulfur antioxidants, heat resistant modification stabilizers, and oxygen scavengers. Preferred among them are the phenol antioxidants, and particularly preferred are alkyl-substituted phenol antioxidants. By adding the antioxidant, the formed film can be prevented from being colored and deteriorated in the strength due to heat, oxidation degradation, or the like in the forming process, without reduction of the transparency, the heat resistance, etc. The above antioxidants may be used singly or in combination of two or more, and the amount thereof is appropriately selected so as not to deteriorate the advantageous effects of the present invention. The amount of the antioxidant is preferably 0.001% to 5% by mass, more preferably 0.01% to 1% by mass, per 100% by mass of the polymer according to the present invention.

Hindered phenol compounds such as 2,6-dialkylphenol derivatives may be used as the antioxidant as described in U.S. Pat. No. 4,839,405, Columns 12 to 14.

Specific examples of the hindered phenol compounds include n-octadecyl 3-(3,5-di-t-butyl-4-hydroxyphenyl)propionate, n-octadecyl 3-(3,5-di-t-butyl-4-hydroxyphenyl)acetate, n-octadecyl 3,5-di-t-butyl-4-hydroxybenzoate, n-hexyl 3,5-di-t-butyl-4-hydroxyphenylbenzoate, n-dodecyl 3,5-di-t-butyl-4-hydroxyphenylbenzoate, neododecyl 3-(3,5-di-t-butyl-4-hydroxyphenyl)propionate, dodecyl β-(3,5-di-t-butyl-4-hydroxyphenyl)propionate, ethyl α-(4-hydroxy-3,5-di-t-butylphenyl)isobutyrate, octadecyl α-(4-hydroxy-3,5-di-t-butylphenyl)isobutyrate, octadecyl α-(4-hydroxy-3,5-di-t-butyl-4-hydroxyphenyl)propionate, 2-(n-octylthio)ethyl 3,5-di-t-butyl-4-hydroxybenzoate, 2-(n-octylthio)ethyl 3,5-di-t-butyl-4-hydroxyphenylacetate, 2-(n-octadecylthio)ethyl 3,5-di-t-butyl-4-hydroxyphenylacetate, 2-(n-octadecylthio)ethyl 3,5-di-t-butyl-4-hydroxybenzoate, 2-(2-hydroxyethylthio)ethyl 3,5-di-t-butyl-4-hydroxybenzoate, diethylglycol bis(3,5-di-t-butyl-4-hydroxyphenyl)propionate, 2-(n-octadecylthio)ethyl 3-(3,5-di-t-butyl-4-hydroxyphenyl)propionate, stearamide N,N-bis[ethylene 3-(3,5-di-t-butyl-4-hydroxyphenyl)propionate], n-butylimino N,N-bis[ethylene 3-(3,5-di-t-butyl-4-hydroxyphenyl)propionate], 2-(2-stearoyloxyethylthio)ethyl 3,5-di-t-butyl-4-hydroxybenzoate, 2-(2-stearoyloxyethylthio)ethyl 7-(3-methyl-5-t-butyl-4-hydroxyphenyl)heptanoate, 1,2-propylene glycol bis[3-(3,5-di-t-butyl-4-hydroxyphenyl)propionate], ethylene glycol bis[3-(3,5-di-t-butyl-4-hydroxyphenyl)propionate], neopentyl glycol bis[3-(3,5-di-t-butyl-4-hydroxyphenyl)propionate], ethylene glycol bis(3,5-di-t-butyl-4-hydroxyphenylacetate), glycerin 1-n-octadecanoate-2,3-bis(3,5-di-t-butyl-4-hydroxyphenylacetate), pentaerythritol tetrakis[3-(3′,5′-di-t-butyl-4′-hydroxyphenyl)propionate], 1,1,1-trimethylolethane tris[3-(3,5-di-t-butyl-4-hydroxyphenyl)propionate], sorbitol hexa[3-(3,5-di-t-butyl-4-hydroxyphenyl)propionate], 2-hydroxyethyl 7-(3-methyl-5-t-butyl-4-hydroxyphenyl)propionate, 2-stearoyloxyethyl 7-(3-methyl-5-t-butyl-4-hydroxyphenyl)heptanoate, 1,6-n-hexanediol bis[(3′,5′-di-t-butyl-4-hydroxyphenyl)propionate], and pentaerythritol tetrakis(3,5-di-t-butyl-4-hydroxyhydrocinnamate). Commercially available hindered phenol antioxidants include IRGANOX 1076 and IRGANOX 1010 (trade names, available form Ciba Specialty Chemicals Corporation).

Specific examples of the other antioxidants include phosphorus antioxidants such as trisnonylphenyl phosphite, triphenyl phosphate, and tris(2,4-di-tert-butylphenyl) phosphite; sulfur antioxidants such as dilauryl 3,3′-thiodipropionate, dimyristyl 3,3′-thiodipropionate, distearyl 3,3′-thiodipropionate, and pentaerythrityl tetrakis(3-laurylthiopropionate); heat resistant modification stabilizers such as 2-tert-butyl-6-(3-tert-butyl-2-hydroxy-5-methylbenzyl)-4-methylphenyl acrylate and 2-[1-(2-hydroxy-3,5-di-tert-pentylphenyl)ethyl]-4,6-di-tert-pentylphenyl acrylate; and oxygen scavengers such as 3,4-dihydro-2H-1-benzopyran compounds described in Japanese Patent Publication No. 8-27508, 3,3′-spirodichromane compounds, 1,1-spiroindane compounds, morpholines, thiomorpholines, thiomorpholine oxides, thiomorpholine dioxides, compounds having a piperazine skeleton moiety, and dialkoxybenzene compounds described in Japanese Laid-Open Patent Publication No. 3-174150. The antioxidant may be a polymer having a part or a regularly distributed pendant group of a moiety of the antioxidant.

### (Acid Scavenger)

The cellulose acylate film of the present invention preferably contains an acid scavenger because the cellulose acylate may be decomposed by an acid at a high temperature.

In the present invention, the acid scavenger is not limited as long as it can be reacted with an acid to inactivate the acid. The acid scavenger is preferably a compound having an epoxy group described in U.S. Pat. No. 4,137,201. The epoxy compound usable as the acid scavenger is known in the art, and examples thereof include various polyglycol diglycidyl ethers, particularly those prepared by a condensation reaction of about 8 to 40 mol of ethylene oxide or the like per 1 mol of a polyglycol; glycerol diglycidyl ethers; metal epoxy compounds such as those usable in a vinyl chloride polymer composition or in combination with the composition; condensation products of an epoxidized ether; bisphenol A diglycidyl ether, i.e. 4,4′-dihydroxydiphenyldimethylmethane; epoxidized unsaturated fatty esters, particularly esters of a fatty acid having 2 to 22 carbon atoms and an alkyl group having 2 to 4 carbon atoms, such as butyl epoxystearate; and epoxidized plant oils and other unsaturated natural oils, such as compositions of an epoxidized long-chain fatty acid triglyceride (e.g., epoxidized soybean oil), which are often referred to as epoxidized natural glycerides or unsaturated fatty acids, and contain a fatty acid generally having 12 to 22 carbon atoms. Further, also commercially available EPON 815C is preferably used as the acid scavenger of the epoxy-containing resin.

Examples of the acid scavengers further include oxetane compounds, oxazoline compounds, alkaline earth metal salts of an organic acid, acetylacetonato complexes, and those described in Japanese Laid-Open Patent Publication No. 5-194788, Paragraph [0068] to [0105].

In the present invention, the acid scavenger may be referred to as an acid cleaning agent, an acid trapping agent, an acid catcher, or the like, without distinction.

### (Light Stabilizer)

In the present invention, a hindered amine light stabilizer (HALS) may be used as a stabilizer against an external light or a backlight from a liquid crystal display, to which the produced polarizer protecting film is exposed. The hindered amine light stabilizer is a known compound, and examples thereof include 2,2,6,6-tetraalkylpiperidine compounds, acid adducts thereof, and metal complexes thereof as described in U.S. Pat. No. 4,619,956, Columns 5 to 11 and U.S. Pat. No. 4,839,405, Columns 3 to 5.

Specific examples of the hindered amine light stabilizers include 4-hydroxy-2,2,6,6-tetramethylpiperidine, 1-allyl-4-hydroxy-2,2,6,6-tetramethylpiperidine, 1-benzyl-4-hydroxy-2,2,6,6-tetramethylpiperidine, 1-(4-t-butyl-2-butenyl)-4-hydroxy-2,2,6,6-tetramethylpiperidine, 4-stearoyloxy-2,2,6,6-tetramethylpiperidine, 1-ethyl-4-salicyloyloxy-2,2,6,6-tetramethylpiperidine, 4-methacryloyloxy-1,2,2,6,6-pentamethylpiperidine, 1,2,2,6,6-pentamethylpiperidine-4-yl β-(3,5-di-t-butyl-4-hydroxyphenyl)propionate, 1-benzyl-2,2,6,6-tetramethyl-4-piperidinyl maleinate, di-2,2,6,6-tetramethylpiperidine-4-yl adipate, di-2,2,6,6-tetramethylpiperidine-4-yl sebacate, di-1,2,3,6-tetramethyl-2,6-diethylpiperidine-4-yl sebacate, di-1-allyl-2,2,6,6-tetramethylpiperidine-4-yl phthalate, 1-acetyl-2,2,6,6-tetramethylpiperidine-4-yl acetate, tri-(2,2,6,6-tetramethylpiperidine-4-yl)trimellitate, 1-acryloyl-4-benzyloxy-2,2,6,6-tetramethylpiperidine, di-(1,2,2,6,6-pentamethylpiperidine-4-yl)dibutylmalonate, di-(1,2,3,6-tetramethyl-2,6-diethylpiperidine-4-yl)dibenzylmalonate, dimethyl-bis(2,2,6,6-tetramethylpiperidine-4-oxy)silane, tris(1-propyl-2,2,6,6-tetramethylpiperidine-4-yl)phosphite, tris(1-propyl-2,2,6,6-tetramethylpiperidine-4-yl)phosphate, N,N′-bis(2,2,6,6-tetramethylpiperidine-4-yl)-hexamethylene-1,6-diamine, N,N′-bis(2,2,6,6-tetramethylpiperidine-4-yl)-hexamethylene-1,6-diacetoamide, 1-acetyl-4-(N-cyclohexylacetoamide)-2,2,6,6-tetramethylpiperidine, 4-benzylamino-2,2,6,6-tetramethylpiperidine, N,N′-bis(2,2,6,6-tetramethylpiperidine-4-yl)-N,N′-dibutyladipamide, N,N′-bis(2,2,6,6-tetramethylpiperidine-4-yl)-N,N′-dicyclohexyl-2-hydroxypropylene, N,N′-bis(2,2,6,6-tetramethylpiperidine-4-yl)-p-xylylene-diamine, 4-(bis-2-hydroxyethyl)amino-1,2,2,6,6-pentamethylpiperidine, 4-methacrylamido-1,2,2,6,6-pentamethylpiperidine, and methyl α-cyano-β-methyl-β-[N-(2,2,6,6-tetramethylpiperidine-4-yl)]aminoacrylate.

At least one of the stabilizers may be added to the film of the present invention. The mass ratio of the light stabilizer to the cellulose acylate is preferably 0.001% to 5% by mass, more preferably 0.005% to 3% by mass, further preferably 0.01% to 0.8% by mass.

### (Ultraviolet Absorber)

When the cellulose acylate film of the present invention is used as a polarizer protecting film disposed outside a liquid crystal cell, it is preferred that an ultraviolet absorber is further added to the film. The ultraviolet absorber is effective for preventing the material of the produced cellulose acylate film from being decomposed by an ultraviolet ray under the usage environment. Though the cellulose acylate has a relatively high ultraviolet resistance, the additive may have an insufficient ultraviolet resistance, and the polarizer and the liquid crystal cell may be poor in ultraviolet resistance. Thus, at least a surface of the polarizer protecting film, which is exposed to the external light or the backlight of the liquid crystal display, preferably contains the ultraviolet absorber.

From the viewpoint of preventing the deterioration of the polarizer or display device due to the ultraviolet ray, it is preferred that the ultraviolet absorber is excellent in absorptivity for an ultraviolet ray with a wavelength of 370 nm or less. Further, from the viewpoint of improving the liquid crystal display properties, it is preferred that the ultraviolet absorber has a small absorption of visible lights with wavelengths of 400 nm or more. Examples of such ultraviolet absorbers include oxybenzophenone compounds, benzotriazole compounds, triazine compounds, salicylate ester compounds, benzophenone compounds, cyanoacrylate compounds, and nickel complex salts. Among them, preferred are benzophenone compounds and benzotriazole compounds with small coloration, and particularly preferred are benzotriazole compounds. Further, the ultraviolet absorber may be selected from absorbers described in Japanese Laid-Open Patent Publication Nos. 10-182621 and 8-337574, and high-molecular ultraviolet absorbers described in Japanese Laid-Open Patent Publication No. 6-148430.

Specific examples of the benzotriazole ultraviolet absorbers useful in the present invention include 2-(2′-hydroxy-5′-methylphenyl)benzotriazole, 2-(2′-hydroxy-3′,5′-di-tert-butylphenyl)benzotriazole, 2-(2′-hydroxy-3′-tert-butyl-5′-methylphenyl)benzotriazole, 2-(2′-hydroxy-3′,5′-di-tert-butylphenyl)-5-chlorobenzotriazole, 2-(2′-hydroxy-3′-(3″,4″,5″,6″-tetrahydrophthalimidomethyl)-5′-methylphenyl)benzotriazole, 2,2-methylene bis(4-(1,1,3,3-tetramethylbutyl)-6-(2H-benzotriazole-2-yl)phenol), 2-(2′-hydroxy-3′-tert-butyl-5′-methylphenyl)-5-chlorobenzotriazole, 2-(2H-benzotriazole-2-yl)-6-(straight or branched dodecyl)-4-methylphenols, and mixtures of octyl-3-[3-tert-butyl-4-hydroxy-5-(chloro-2H-benzotriazole-2-yl)phenyl]propionate and 2-ethylhexyl-3-[3-tert-butyl-4-hydroxy-5-(5-chloro-2H-benzotriazole-2-yl)phenyl]propionate, though the ultraviolet absorber is not limited to the specific examples.

Further, TINUVIN 109, TINUVIN 171, TINUVIN 234, and TINUVIN 360, commercially available from Ciba Specialty Chemicals Corporation, may be used as the ultraviolet absorber.

Specific examples of the benzophenone compounds include 2,4-dihydroxybenzophenone, 2,2′-dihydroxy-4-methoxybenzophenone, 2-hydroxy-4-methoxy-5-sulfobenzophenone, and bis(2-methoxy-4-hydroxy-5-benzoylphenyl)methane, though not restrictive.

In the present invention, the amount of the ultraviolet absorber is preferably 0.1% to 20% by mass, more preferably 0.5% to 10% by mass, further preferably 1% to 5% by mass. Two or more ultraviolet absorbers may be used in combination.

### (Matting Agent)

Fine particles of a matting agent or the like may be added to the cellulose acylate film of the present invention to improve the lubricity. The fine particles may be composed of an inorganic compound or an organic compound. The fine particles of the matting agent preferably have smaller particle sizes, and examples of materials for the fine particles include crosslinked polymers and inorganic substances such as silicon dioxide, titanium dioxide, aluminum oxide, zirconium oxide, calcium carbonate, kaolins, talcs, calcined calcium silicates, hydrated calcium silicates, aluminum silicate, magnesium silicate, and calcium phosphate. Among the materials, silicon dioxide is preferable for reducing the haze of the film. The fine particles of the silicon dioxide are often surface-treated with an organic substance, and such modified particles are preferred in view of reducing the haze of the film.

Preferred examples of the organic substances for the surface treatment include halosilanes, alkoxysilanes, silazanes, and siloxanes. As the average particle diameter of the fine particles is increased, the effect of improving the lubricity is increased. On the other hand, as the average particle diameter is reduced, the transparency is improved. The average particle size of the secondary particles may be 0.05 to 1.0 μm, and is preferably 5 to 50 nm, more preferably 7 to 14 nm. The fine particles are preferably used for forming a roughness of 0.01 to 1.0 μm on the surface of the cellulose acylate film. The mass ratio of the fine particles to the cellulose acylate is preferably 0.005% to 0.3% by mass.

Examples of the fine silicon dioxide particles include AEROSIL 200, 200V, 300, R972, R972V, R974, R202, R812, OX50, and TT600 available from Nippon Aerosil Co., Ltd. Preferred among them are AEROSIL 200V, R972, R972V, R974, R202, and R812. Two or more types of the fine particles may be used in combination, and in this case the mixing ratio may be appropriately selected. For example, two types of the fine particles different in the average particle diameter or material, such as AEROSIL 200V and R972V, may be used at a mass ratio of 0.1:99.9 to 99.9:0.1.

The fine particles of the matting agent may act also to improve the strength of the film. Further, the fine particles may act to improve the orientation of the cellulose acylate in the cellulose acylate film of the present invention.

### (Retardation Increasing Agent)

A polarizing plate may be prepared by forming an oriented film as a liquid crystal layer on the cellulose acylate film of the present invention, so that the retardations of the cellulose acylate film and the liquid crystal layer are combined to improve the optical compensatory property, thereby improving the liquid crystal display quality. An aromatic compound having two or more aromatic rings, described in European Patent No. 911,656A2, etc., may be used as a retardation increasing agent. Two or more aromatic compounds may be used in combination. The aromatic ring of the aromatic compound may be an aromatic hydrocarbon ring or an aromatic heterocyclic ring, and is particularly preferably an aromatic heterocyclic ring. The aromatic heterocyclic ring is generally an unsaturated heterocycle, and is particularly preferably a 1,3,5-triazine ring.

### (Other Additives)

Examples of the other additives include fillers, inorganic compounds such as silica and silicate salts, dyes, pigments, fluorescent substances, refractive index modifiers, and gas permeation inhibitors. Further, additives having such functions, other than these examples, may be used in the present invention.

The cellulose acylate film containing the additive may be formed by a method containing the steps of mixing components in the solid or liquid states, thermally melting and kneading the mixture to prepare a uniform melt, and casting the melt. Alternatively, the cellulose acylate film may be formed by a method containing the steps of dissolving all the components in a solvent to prepare a uniform solution, removing the solvent to prepare a mixture of the additive and the cellulose acylate, and thermally melting and casting the mixture.

The cellulose acylate film preferably contains at least one of the degradation inhibitor, the ultraviolet absorber, and the matting agent, and further preferably contains all of them.

### [Production of Cellulose Acylate Film]

The film forming material (including the cellulose acylate, the plasticizer, and the additive) has to be such that a volatile component is generated in a small amount or not generated at all therefrom in the melting step and the film forming process. Such a film forming material is not foamed in thermal melting step, and thus internal defects and surface flatness deterioration of the film can be reduced or prevented.

In the step of melting the film forming material, the volatile component content is preferably 1% by mass or less, more preferably 0.5% by mass or less, further preferably 0.2% by mass or less, still further preferably 0.1% by mass or less. In the present invention, the heating loss of the material from 30° C. to 250° C. is measured as the volatile component content by a differential thermogravimetric measurement apparatus TG/DTA200 manufactured by Seiko Instruments Inc.

It is preferred that the volatile component such as water or a solvent is removed from the film forming material before the film forming process or in the heating step. The volatile component may be removed by a known drying method such as a heating method, a decompression method, or a heating decompression method, in the air or an inert gas such as nitrogen. In view of the quality of the film, the known drying method is preferably carried out at a temperature, at which the film forming material is not decomposed.

By drying the film forming material before the film forming process, the generation of the volatile component can be reduced. The resin may be dried alone, and a mixture or a compatible liquid of the resin and another component may be dried separately. The drying temperature is preferably 100° C. or higher. In a case where the film forming material to be dried contains a component having a glass transition temperature, the material is often fused and made hard to handle at a drying temperature higher than the glass transition temperature. Thus, the drying temperature is preferably equal to or less than the glass transition temperature. In a case where a plurality of components in the film forming material have glass transition temperatures, the drying temperature is determined based on the lower glass transition temperature. The drying temperature is more preferably at least 100° C. and at most (the glass transition temperature—5)° C., further preferably at least 110° C. and at most (the glass transition temperature—20)° C. The drying time is preferably 0.5 to 24 hours, more preferably 1 to 18 hours, further preferably 1.5 to 12 hours. When the drying temperature is too low, the efficiency of removing the volatile component is reduced, and a remarkably longer drying time is required. The drying process may be carried out in two or more steps. For example, the drying process may contain a pre-drying step performed before the storage of the material and an immediate drying step performed immediately before or in one week before the film forming process.

The melt film forming method may contain a step of melt extrusion, press forming, inflation forming, injection forming, blow forming, stretching, etc. The melt extrusion step is preferred from the viewpoint of preparing an optical film excellent in mechanical strength, surface accuracy, etc. The melt film forming method used in the present invention will be described below with reference to an example of the melt extrusion step.

In the melt film forming method used in the present invention, the above film components are mixed, melted using an extruder, and melt-extruded from a casting die onto a first cooling roll. The melt is brought into contact with the first cooling roll, and then with a second cooling roll. Then, the melt is brought into contact with a third cooling roll, and a fourth cooling roll, if necessary, and thereby is cooled and solidified into the film. In this step, it is further preferred that a touch roll is used to press the melt film (the melt) to the first cooling roll. The touch roll has an elastic surface, and acts as a nip in combination with the first cooling roll. The touch roll will be hereinafter described in detail.

In the method of the present invention for producing the optical film, the conditions of the melt extrusion may be the same as conditions commonly used for another thermoplastic resin such as a polyester. The film material is preferably dried before the melt extrusion. The water content of the film material is reduced by a vacuum or decompression dryer, a dehumidified hot air dryer, or the like, preferably to 1,000 ppm or less, more preferably to 200 ppm or less.

For example, the film material including the cellulose acylate and the plasticizer is dried under hot air, vacuum, or reduced pressure, melted by an extruder at an extrusion temperature of 200° C. to 300° C., more preferably 230° C. to 260° C., and filtrated through a breaker plate, a leaf disc filter, etc. to remove contaminants.

It is preferred that the film material is introduced through a feed hopper to the extruder under vacuum, reduced pressure, or an inert gas, to prevent oxidative decomposition or the like of the film material.

In a case where the additive such as the plasticizer is not added beforehand, the additive may be kneaded into the film material during the extrusion. A mixer such as a static mixer is preferably used to uniformly add the additive.

It is preferred that the cellulose resin, the plasticizer, and the optional additive such as the stabilizer are mixed before the melting step. It is further preferred that the cellulose resin and the stabilizer are mixed first. The components may be mixed using a mixer, and may be mixed in the preparation of the cellulose resin as described above. The mixer may be a common one such as a V-type mixer, a conical screw mixer, a horizontal cylinder mixer, a Henschel mixer, or a ribbon mixer.

After mixing the film components, the mixture may be directly melted using the extruder as described above. Alternatively, a pellet of the film forming material may be prepared and then melted using the extruder. In a case where the film forming material contains a plurality of components having different melting points, a semi-melt may be prepared at a temperature, at which only a component having a lower melting point is melted, and then added to the extruder. In a case where the film forming material contains a component liable to be easily heat-decomposed, the method of directly melting the mixture without preparing the pellet, and the method of preparing the semi-melt are preferred from the viewpoint of reducing the number of melting steps.

The extruder may be selected from various commercially available products, and is preferably a melt kneading extruder. The extruder may be a uniaxial or biaxial extruder. In the method of directly melting the film forming material without preparing the pellet, the biaxial extruder is preferably used to achieve sufficient kneading. In this method, by using a Maddock-, Unimelt-, or Dulmage-type kneading screw, also the uniaxial extruder may be used to achieve sufficient kneading. In the methods of preparing the pellet or the semi-melt of the film forming material, the extruder may be the uniaxial or biaxial extruder.

The extrusion step and the next cooling step are preferably carried out at a reduced oxygen concentration under a reduced pressure or an inert gas such as a nitrogen gas.

The internal temperature of the extruder for melting the film forming material may be appropriately selected depending on the viscosity of the film forming material, the discharge rate of the film forming material, the desired film thickness, etc. The temperature is generally Tg to Tg+100° C., preferably Tg+10° C. to Tg+90° C., in which Tg is the glass transition temperature of the film. In the extrusion step, the melt viscosity is 1 to 10,000 Pas, preferably 10 to 1,000 Pa·s. The residence time of the film forming material in the extruder is preferably short. The residence time is generally 5 minutes or less, preferably 3 minutes or less, more preferably 2 minutes or less. The residence time can be shortened by controlling the supply rate of the material, the L/D ratio, the rotation rate of a screw, the slot depth of a screw, etc., though the residence time depends on the type of the extruder and the extrusion conditions.

The shape, rotation rate, etc. of a screw of the extruder may be appropriately selected depending on the viscosity, discharge rate, etc. of the film forming material. In the present invention, the shear rate of the extruder is 1/second to 10,000/second, preferably 5/second to 1,000/second, more preferably 10/second to 100/second. Further, the gap between a hill and a barrel in the screw is preferably controlled as described above.

The extruder usable in the present invention is generally available as a plastic forming apparatus. It is also preferred that the thickness accuracy of the film is improved by attaching a gear pump to the extruder to prevent pulsating flow.

The film forming material is extruded from the extruder, transported to a casting die, and extruded from a slit of the casting die into a film shape. The casting die is not particularly limited as long as it can be used for producing a sheet, a film, etc. The material of the casting die may be sprayed or plated with a hard chrome, chromium carbide, chromium nitride, titanium carbide, titanium carbonitride, titanium nitride, super steels, or a ceramic such as tungsten carbide, aluminum oxide, or chromium oxide, and may be surface-treated by a buffing treatment, a wrapping treatment using a grindstone of #1000 or more count, a planar cutting treatment using a grinding diamond of #1000 or more count (in a cutting direction perpendicular to the flow direction of the resin), an electrochemical polishing treatment, a composite electrochemical polishing treatment, etc. Lips of the casting die are preferably composed of the same material. The surface accuracy of each lip is preferably 0.5 S or less, more preferably 0.2 S or less.

The gap of the slit in the casting die can be controlled. Thus, one of a pair of lips for forming the slit is a low-rigid, easily deformable, flexible lip, and the other is a static lip. A large number of heat bolts are arranged at a constant pitch in the width direction of the casting die, i.e. the length direction of the slit. Each heat bolt passes longitudinally through a block containing an embedded electric heater and a cooling medium path. The base of the heat bolt is fixed to the die body, and the end is in contact with the external surface of the flexible lip. The input of the embedded electric heater is controlled to change the temperature of each block while constantly air-cooling the block. The heat bolts are thermally expanded or contracted, whereby the flexible lip is displaced to control the film thickness. The electric power or ON ratio of the heater for the heat bolts may be controlled based on a correction signal from a control unit. For example, a web thickness information is detected by a thickness meter disposed downstream of the die, fed back to the control unit, and compared with the preset thickness information by the control unit to obtain the correction signal. Each heat bolt preferably has a length of 20 to 40 cm and a diameter of 7 to 14 mm. The large number, e.g. several tens, of the heat bolts are arranged preferably at a pitch of 20 to 40 mm. A gap controlling member mainly composed of a bolt, manually moved in the shaft direction to control the slit gap, may be used instead of the heat bolts. The slit gap controlled by the gap controlling member is generally 200 to 1000 μm, preferably 300 to 800 μm, more preferably 400 to 600 μm.

The melt extruded from the casting die is solidified on the first and second cooling rolls. Each of the first and second cooling rolls is a seamless steel pipe having a thickness of about 20 to 30 mm, and the surface of the steel pipe is mirror-finished. A cooling liquid is flowed in the steel pipe, and acts to absorb heat from a film on the first and second cooling rolls.

The touch roll for pressing the melt to the first cooling roll has an elastic surface, which is deformed along the surface of the first cooling roll to form a nip.

The touch roll may be an elastic roller disposed inside a flexible metal sleeve. This type of touch roll is hereinafter referred to as a touch roll A.

The flexible metal sleeve is composed of a stainless steel having a thickness of 0.3 mm. When the thickness is too small, the metal sleeve is insufficient in strength. On the other hand, when the thickness is too large, the metal sleeve is insufficient in elasticity. Thus, the thickness of the metal sleeve is preferably 0.1 to 1.5 mm. The elastic roller is a roll-like rubber disposed on a metal inner cylinder, which is rotatable using a bearing. When the touch roll A is pressed to the first cooling roll, the metal sleeve is pressed to the first cooling roll by the elastic roller, and the metal sleeve and the elastic roller are deformed along the shape of the first cooling roll to form the nip. A temperature controlling medium is flowed in a space between the metal sleeve and the elastic roller.

Further, the touch roll may be such that a high-rigid metal inner cylinder is disposed concentrically in an outer cylinder of a flexible seamless stainless steel pipe having a thickness of 4 mm. This type of touch roll is hereinafter referred to as a touch roll B. A temperature controlling medium is flowed in a space between the outer and inner cylinders. More specifically, in the touch roll B, outer cylinder supporting flanges are disposed on the both end rotation shafts, and the thin metal outer cylinder is attached between the peripheries of the outer cylinder supporting flanges. A fluid discharge hole is formed as a fluid return path at the center of one of the rotation shafts, and a fluid supply pipe is formed concentrically in the fluid discharge hole. The fluid supply pipe is connected and fixed to a fluid axis cylinder, which is disposed at the center of the thin metal outer cylinder. Inner cylinder supporting flanges are formed at the both ends of the fluid axis cylinder, and the metal inner cylinder having a thickness of about 15 to 20 mm is attached between the peripheries of the inner cylinder supporting flanges and the other outer cylinder supporting flange. A cooling liquid flow space of about 10 mm is formed between the metal inner cylinder and the thin metal outer cylinder, and an outlet and an inlet for connecting the flow space to an intermediate path disposed outside the inner cylinder supporting flanges are formed in the vicinity of the ends of the metal inner cylinder, respectively.

The thickness of the outer cylinder is reduced within the range of the thin cylinder theory of the elastic dynamics to obtain softness, flexibility, and restoration property, like rubber elasticity. In the thin cylinder theory, the flexibility is evaluated using a value of t/r in which t is a thickness and r is a roll radius. The smaller the value of t/r is, the higher the flexibility becomes.

When the touch roll B has the t/r value of 0.03 or less, the flexibility is optimized. A common touch roll has a roll diameter R of 200 to 500 mm (the roll radius r=R/2), a roll effective width L of 500 to 1600 mm, and a horizontally long shape with an r/L value of less than 1. For example, when the roll diameter R is 300 mm and the roll effective width L is 1200 mm, the thickness t is appropriately 150×0.03=4.5 mm or less. In a case where a melt sheet having a width of 1300 mm is pressed at an average linear pressure of 100 N/cm, by controlling the outer cylinder thickness to 3 mm, a relative spring constant equal to that of a rubber roll with the same shape can be obtained. Further, the nip width k (the width of the nip in the rolling direction between the outer cylinder and the cooling roll) is about 9 mm, which is similar to the nip width of the rubber roll of 12 mm. Thus, it is clear that the touch roll can exhibit the same pressing properties as the rubber roll. It should be noted that the bending degree is about 0.05 to 0.1 mm under this nip width k.

In the above example, the t/r value is 0.03 or less. When the roll diameter R is 200 to 500 mm, a thickness t within the range of 2 mm≦t≦5 mm is remarkably practicable. A roll having such a thickness can be easily machined with sufficient flexibility. When the thickness is less than 2 mm, the roll cannot be machined with high accuracy due to the elastic deformation.

When the roll diameter R is within a common range and the thickness t is within the range of 2 mm≦t≦5 mm, the t/r value is within the range of 0.008≦t/r≦0.05. In practical use, the thickness may be increased in proportion to the roll diameter at a t/r value of near 0.03. For example, the thickness t may be 2 to 3 mm when the roll diameter R is 200, and the thickness t may be 4 to 5 mm when the roll diameter R is 500.

Among the above touch rolls, the touch roll B excellent in durability is more preferred.

The touch roll A or B is biased to the first cooling roll. When F represents the biasing force of a biasing means and W represents the width of the film at the nip in the rotation axis direction of the first cooling roll, the F/W value (the linear pressure) is 10 to 150 N/cm. In this embodiment, the nip is formed between the touch roll A or B and the first cooling roll 5, and the flatness of the film may be corrected during the film is transported through the nip. Thus, as compared with a rigid touch roll incapable of forming a nip with the first cooling roll, in this embodiment, the film can be pressed for a longer time at a lower linear pressure, whereby the flatness can be more reliably corrected. When the linear pressure is lower than 10 N/cm, a die line cannot be sufficiently eliminated. On the other hand, when the linear pressure is higher than 150 N/cm, the film cannot be easily transported through the nip, resulting in nonuniform thickness.

Further, the touch roll A or B has the metal surface flatter than rubber surfaces, so that the flatness of the film can be increased. The elastic roller may comprise an elastic material such as an ethylene propylene rubber, a neoprene rubber, or a silicone rubber.

In the step of pressing the film by the touch roll, the temperature T of the film preferably satisfies the inequality Tg<T<Tg+110° C., in which Tg represents the glass transition temperature of the film material including the cellulose acylate, the plasticizer, the stabilizer, etc. When the film temperature T is lower than Tg, the film has an excessively high viscosity, thereby failing to correct the die line. On the other hand, the film temperature T is higher than Tg+110° C., the film surface cannot be in uniform contact with the roll, thereby failing to correct the die line. The temperature T preferably satisfies the inequality Tg+10° C.<T<Tg+90° C., further preferably satisfies the inequality Tg+20° C.<T<Tg+70° C. The film temperature in the pressing step may be appropriately changed by controlling the temperature of the melt extruded from the casting die and the distance between the first cooling roll and the casting die. The temperature of the melt can be controlled by increasing or lowering the temperatures of the extruder and the casting die.

In the present invention, preferred examples of materials for the first and second cooling rolls include carbon steels, stainless steels, and resins. The surface accuracy is such that the surface roughness (section value) is preferably 0.3 S or less, more preferably 0.01 S or less.

In the present invention, the pressure in the area from the opening (the lip) of the casting die to the first cooling roll is reduced preferably to 70 kPa or less, more preferably to 50 to 70 kPa. The pressure of 70 kPa or less may be maintained by covering and depressurizing the area from the casting die to the roll with a pressure-tight member, though not restrictive. An aspirator used for this decompression is preferably subjected to a treatment for preventing a sublimate from adhering to the aspirator, such as a heating treatment using a heater. In the present invention, when the suction power of the aspirator is too small, the sublimate cannot be effectively removed. Thus, it is necessary to appropriately select the suction power.

In the present invention, the melt film of the cellulose acylate resin is transported from the casting die and brought into contact with the first cooling roll, the second cooling roll, and the third cooling roll in this order, and thereby the melt film is cooled and solidified to obtain an unstretched cellulose acylate resin film.

The unstretched film according to the present invention can be formed by a melt film forming method other than the above method using the touch roll, such as a method described in U.S. Pat. Nos. 2,492,978, 2,739,070, 2,739,069, 2,492,977, 2,336,310, 2,367,603, and 2,607,704, UK Patent Nos. 64,071 and 735,892, Japanese Patent Publication Nos. 45-9074, 49-4554, 49-5614, 60-27562, 61-39890, and 62-4208, etc.

It is preferred that, in thus obtained film, the number of contaminants with sizes of 5 to 50 μm is 200 or less, and the number of contaminants with sizes of more than 50 μm is 0, per 250 mm² of the film. It is more preferred that the number of contaminants with sizes of 5 to 50 μm is 100 or less per 250 mm² of the film. Such contaminants can be removed by filtration in the cellulose acylate synthesis step or the melt film forming step.

### 2. Solution Cast Film Forming Method

The cellulose acylate used in the solution cast film forming method according to the present invention has the above composition and a number average molecular weight of 70,000 to 300,000, preferably 90,000 to 200,000. The ratio of the weight average molecular weight Mw/the number average molecular weight Mn of the cellulose acylate is preferably 1.5 to 5.5, more preferably 2.0 to 5.0, further preferably 2.5 to 5.0, still further preferably 3.0 to 5.0.

In the solution cast film forming method according to the present invention, the cellulose acylate is dissolved in a solvent to prepare a dope. Examples of the solvents include methylene chloride, methyl acetate, ethyl acetate, amyl acetate, acetone, tetrahydrofuran, 1,3-dioxolan, 1,4-dioxolan, cyclohexanone, 2,2,2-trifluoroethanol, 2,2,3,3-tetrafluoro-1-propanol, and 1,3-difluoro-2-propanol. Though a chlorine-containing solvent such as methylene chloride has no technical problems, it is preferred that the use of the chlorine-containing solvent is minimized from the viewpoints of conservation of global environment and working environment. Methyl acetate, ethyl acetate, acetone, or the like have less environmental problems. It is particularly preferred that the mass ratio of methyl acetate is 50% by mass or more to the total mass of organic solvents. When 5% to 30% of acetone is used in combination with methyl acetate, the viscosity of the dope can be advantageously reduced. The term “the use of the chlorine-containing solvent is minimized” means that the ratio of the chlorine-containing solvent is controlled to 10% or less to the total of organic solvents. The ratio of the chlorine-containing solvent is preferably 5% or less, most preferably 0%.

The dope preferably contains 1% to 30% of an alcohol having 1 to 4 carbon atoms, in addition to the above organic solvent. In a case where the dope contains the alcohol, the solvent is vaporized after casting the dope on a casting support, and the web (the film formed by casting the dope on the support) is converted to the gel state. Thus obtained web is excellent in strength, and can be easily peeled from the support. Further, the dissolution of the cellulose acylate can be accelerated by using the alcohol. Examples of the alcohols having 1 to 4 carbon atoms include methanol, ethanol, n-propanol, iso-propanol, n-butanol, sec-butanol, and tert-butanol. Among them, ethanol is preferred from the viewpoints of stability, boiling point, drying property, nontoxicity, etc. of the dope.

In general, the solid content of the dope is preferably 10% to 40%, and the viscosity of the dope is preferably 100 to 500 poise in view of the flatness of the film. The dope prepared in the above manner is filtrated using a filter material, defoamed, and then transported by a pump to the next zone.

The dope may contain a plasticizer, a matting agent, an ultraviolet absorber, an antioxidant, a dye, etc.

### <Plasticizer>

The plasticizer may be an alkyl phthalyl alkyl glycolate, and examples thereof include methyl phthalyl methyl glycolate, ethyl phthalyl ethyl glycolate, propyl phthalyl propyl glycolate, butyl phthalyl butyl glycolate, octyl phthalyl octyl glycolate, methyl phthalyl ethyl glycolate, ethyl phthalyl methyl glycolate, ethyl phthalyl propyl glycolate, methyl phthalyl butyl glycolate, ethyl phthalyl butyl glycolate, butyl phthalyl methyl glycolate, butyl phthalyl ethyl glycolate, propyl phthalyl butyl glycolate, butyl phthalyl propyl glycolate, methyl phthalyl octyl glycolate, ethyl phthalyl octyl glycolate, octyl phthalyl methyl glycolate, and octyl phthalyl ethyl glycolate.

The plasticizer may be a phosphate ester, and examples thereof include triphenyl phosphate, tricresyl phosphate, and phenyldiphenyl phosphate.

The plasticizer may be a carboxylate ester, and examples thereof include phthalate esters such as dimethyl phthalate, diethyl phthalate, dibutyl phthalate, dioctyl phthalate, and diethylhexyl phthalate; and citrate esters such as acetyltrimethyl citrate, acetyltriethyl citrate, and acetyltributyl citrate. Further, butyl oleate, methylacetyl recinoleate, dibutyl sebacate, triacetin, and the like may be used singly or in combination.

Two or more plasticizers may be used in combination if necessary. The ratio of the phosphate ester plasticizer is preferably 80% or less. The hydrolysis of the cellulose acylate film is prevented to improve the durability at the preferred ratio. The phosphate ester plasticizer is used more preferably in a further small amount. It is particularly preferred that only the phthalate or glycolate ester plasticizer is used. Among the above plasticizers, preferred are methyl phthalyl methyl glycolate, ethyl phthalyl ethyl glycolate, propyl phthalyl propyl glycolate, butyl phthalyl butyl glycolate, and octyl phthalyl octyl glycolate, and particularly preferred is ethyl phthalyl ethyl glycolate. Two or more of these alkyl phthalyl alkyl glycolate plasticizers may be used as a mixture. The plasticizer may be added together with the cellulose acylate or the solvent before the preparation of the cellulose acylate solution, and may be added in or after the preparation.

### <Dye>

The dye may be added to improve the yellow index of the film. The cellulose acylate is slightly yellowish, and thus the dye is preferably capable of grayish coloration, which is used generally in a photographic support. The dye preferably shows a blue or purple color. The film does not need to be light piping prevention-treated unlike the photographic support, and therefore the amount of the dye may be small. The ratio of the dye to the cellulose acylate is preferably 1 to 100 ppm, more preferably 2 to 50 ppm. A plurality of the dyes may be appropriately combined to obtain the grayish color.

### <Lubricant>

When the film is poor in lubricity, the film surfaces are often blocked each other, resulting in poor handling. The film according to the present invention preferably contains a matting agent, and examples thereof include crosslinked polymers and fine particles of inorganic substances such as silicon dioxide, titanium dioxide, calcined calcium silicates, hydrated calcium silicates, aluminum silicate, magnesium silicate, and calcium phosphate.

The fine particles of silicon dioxide or the like are preferably surface-treated with an organic substance to reduce the haze of the film. Preferred examples of the organic substances for the surface treatment include halosilanes, alkoxysilanes, silazanes, and siloxanes. A larger average diameter of the fine particles is preferred from the viewpoint of the matting effect, and a smaller average diameter is preferred from the viewpoint of the transparency. Thus, the average primary particle diameter of the fine particles is generally 0.1 Mm (100 nm) or less, preferably 5 to 50 nm, more preferably 7 to 14 nm. Examples of the fine silicon dioxide particles include AEROSIL 200, 200V, 300, R972, R972V, R974, R202, R812, OX50, and TT600 available from Nippon Aerosil Co., Ltd. Preferred among them are AEROSIL 200V, R972, R972V, R974, R202, and R812. The matting agent is preferably added such that the film has a haze of 0.6% or less and a dynamic friction coefficient of 0.5 or less. The ratio of the matting agent for this purpose to the cellulose acylate is preferably 0.005% to 0.3%.

### <Ultraviolet Absorber>

The liquid crystal display devices have been used also in the open air. Thus, it is also important to provide the polarizing plate protecting film with an ultraviolet cutting function. The film of the present invention preferably contains an ultraviolet absorber. It is preferred that the ultraviolet absorber is excellent in absorptivity of an ultraviolet ray having a wavelength of 370 nm or less from the viewpoint of preventing the deterioration of the liquid crystal. It is also preferred that the ultraviolet absorber is practically poor in absorptivity of visible lights having wavelengths of 400 nm or more from the viewpoint of improving the liquid crystal display properties. Particularly, the 370-nm wavelength light transmittance of the ultraviolet absorber has to be 10% or less.

The ultraviolet absorber for this purpose preferably has no absorptivity in the visible region, and examples thereof include benzotriazole compounds, benzophenone compounds, and salicylic acid compounds. Specific examples thereof include 2-(2′-hydroxy-5-methylphenyl)benzotriazole, 2-(2′-hydroxy-3′,5′-di-t-butylphenyl)benzotriazole, 2-(2′-hydroxy-3′-di-t-butyl-methylphenyl)benzotriazole, 2,4-dihydroxybenzophenone, 2-hydroxy-4-methoxybenzophenone, 2-hydroxy-4-n-octoxybenzophenone, 4-dodecyloxy-2-hydroxybenzophenone, 2,2′,4,4′-tetrahydroxybenzophenone, 2,2′-dihydroxy-4,4′-dimethoxybenzophenone, phenyl salicylate, and methyl salicylate.

In the present invention, it is preferred that one or more of these ultraviolet absorbers are used. Two or more different ultraviolet absorbers may be used in combination.

The ultraviolet absorber may be added directly to the dope, and may be dissolved in an organic solvent such as an alcohol, methylene chloride, or dioxolan and then added to the dope. The ultraviolet absorber insoluble in the organic solvent, such as an inorganic powder, may be dispersed in the organic solvent and the cellulose acylate by using a dissolver or a sand mill, and then added to the dope.

In the present invention, the ratio of the ultraviolet absorber to the cellulose acylate is 0.1% to 2.5%, preferably 0.5% to 2.0%, more preferably 0.8% to 2.0%. When the ratio of the ultraviolet absorber is more than 2.5%, the transparency of the film is deteriorated.

### <Stabilizer>

A hindered phenol compound is preferably used to improve the heat resistance of the film. The ratio of the compound to the cellulose acylate is preferably 1 ppm (0.0001%) to 1.0%, more preferably 10 to 1000 ppm. Further, a heat stabilizer such as a salt of an alkaline earth metal (calcium, magnesium, etc.) may be added to the film material.

### <Other Additives>

Further, another additive such as an antistatic agent, a flame retardant, a lubricant, or an oil may be appropriately added to the film material.

### <Filtration>

When a cellulose acylate material containing insoluble contaminants is formed into a film, the contaminants cause diffuse reflection in the film. Thus, in a liquid crystal display device using such a film, a light from a liquid crystal cell is scattered, deteriorating the displaying properties. It is difficult to detect the contaminants under an ordinary light. The contaminants can be observed as bright spots in the dark, and the size and the number thereof can be easily measured such that two polarizing plates are placed in the orthogonal state (the crossed nicols state), the cellulose acylate film is placed between the polarizing plates, and a light from a light source is irradiated thereto from the opposite direction. It is preferred that the number of the contaminants with sizes of 5 to 50 μm is 200 or less, and the number of the contaminants with sizes of more than 50 μm is 0, per 250 mm² of the film. It is more preferred that the number of the contaminants with sizes of 5 to 50 μm is 100 or less per 250 mm² of the film. The contaminants with sizes of less than 5 μm give no problems in visual observation. On the other hand, the contaminants with sizes of more than 50 μm are hardly generated in common cellulose acylate producing methods, and metal particles and sealing material particles with sizes of more than 50 μm are removed in the methods. Thus, the dissolved dope is preferably subjected to filtration to remove the contaminants. A filter for the filtration is not particularly limited as long as it is resistant to the organic solvent. Examples of the filters include burned metal filters, metal fiber filters, resin filters (such as woven cloths and nonwoven cloths), ceramic filters, glass filters, and paper filters. The average pore size of the filter may be appropriately selected depending on the size of the contaminant to be removed, and is generally 0.1 to 100 μm. The filter may be used singly, and a plurality of the filters may be tandemly arranged. It is preferred that the filtration is carried out using a paper filter having a water retention time of 20 seconds or more at a filtration pressure of 1.6 MPa or less. It is more preferred that the filtration is carried out using a paper filter having a water retention time of 30 seconds or more at a filtration pressure of 1.2 MPa or less, and it is further preferred that the filtration is carried out using a paper filter having a water retention time of 40 seconds or more at a filtration pressure of 1.0 MPa or less. A stack of two paper filters is preferably used in the filtration. The filtration pressure can be controlled by appropriately selecting the filtration flow rate and the filtering area.

### <Solution Casting>

The obtained dope is cast on the support to form the film. A band method or a drum method may be used in the film formation. Then, the film is peeled from the support, and transported in a drying zone under a tension while drying.

Casting step: The dope is transported through a pressurizing-type constant gear pump to a pressure die. In a casting zone, the dope is cast from the pressure die onto a casting support (which may be hereinafter referred to as a support) of an endless metal belt capable of continuous transport or a rotatable metal drum. The casting support has a mirror-finished surface. Though the dope may be cast by a doctor blade method of using a blade to control the thickness of the dope film, or a reverse roll coater method of using an inversely rotating roll to control the thickness, it is preferred that the dope is cast by using the pressure die. In the pressure die method, the shape of the opening slit can be controlled, whereby the film can be easily formed with uniform thickness. A coat hanger die or a T die can be preferably used as the pressure die. To increase the film forming speed, two or more pressure dies may be used, and the dope may be divided to form a film with a multilayer structure.

Solvent evaporation step: The web is heated on the casting support to vaporize the solvent. The solvent may be vaporized by a method of flowing air from the web, a method of using a liquid for heating the back side of the support, and/or a method of using radiation heat for heating the both sides. The method using a liquid for heating the back side is effective. The methods may be preferably used in combination.

Peeling step: After vaporizing the solvent on the support, the web is peeled off from the support in a peeling zone. The peeled web is transported to the next zone. In the peeling step, when the residual solvent content of the web (obtained by the following equation) is too high, the web cannot be easily peeled. On the other hand, when the web is excessively dried on the support, the web may partly fall away during the peeling step. A gel casting method may be used to increase the film forming rate. In the case of using the gel casting method, the web can be peeled even at a high residual solvent content. In this case, a poor solvent for the cellulose acylate may be added to the dope, and the dope may be converted to the gel state after the casting. Further, in this case, the web may be converted to the gel state by cooling the support. Furthermore, a metal salt may be added to the dope. By converting the web to the gel on the support, the strength of the resultant film can be increased, and the peeling can be accelerated to increase the film forming rate. In a case where the web is peeled at a high residual solvent content, the web may be too soft to deteriorate the flatness. Further, in this case, twisting or swelling may be caused by the peeling tension. Thus, the residual solvent content is determined in view of both the productivity and quality.

Drying step: The web is dried using a drying apparatus for transporting the web to rolls arranged in a zigzag, and/or a tenter apparatus for transporting the web while fixing the both ends of the web with a pin or a clip. The web is generally dried by blowing a hot air onto the both surfaces of the web. A microwave may be applied to the web instead of the hot air to heat the web. When the web is excessively rapidly dried, the flatness of the resultant film may be deteriorated. The web may be rapidly dried at a high temperature after the residual solvent content is reduced to 8% or less. In the overall drying step, the drying temperature is generally 40° C. to 250° C., preferably 70° C. to 180° C. The drying temperature, the drying air flow rate, and the drying time depend on the solvent. The drying conditions may be appropriately selected depending on the type of the solvent and the combination thereof.

In the drying step, the web may shrink in the width direction depending on the evaporation rate of the solvent. As the web is dried rapidly at a high temperature, the shrinkage of the web is increased. It is preferred that the web is dried while reducing the shrinkage as much as possible from the viewpoint of improving the flatness of the resultant film. For example, a tenter method, wherein a part or whole of the drying step being carried out while fixing the both width direction ends of the web by clips, is preferably used as described in Japanese Laid-Open Patent Publication No. 62-46625 from this viewpoint.

Winding step: When the residual solvent content of the web becomes 2% or less, the resultant film is wound. The residual solvent content may be reduced to 0.4% or less to obtain a dimensionally stable film. The method of winding may be a general method, and may be appropriately selected from constant torque methods, constant tension methods, taper tension methods, program tension control methods using a constant internal stress, etc.

The residual solvent content can be obtained using the following equation.

Residual solvent content (%)=(M−N)/N×100

In the equation, M represents the mass of the web at an optional time point, and N represents the mass thereof after drying the web having the mass M at 110° C. for 3 hours.

The thickness of the cellulose acylate film may be controlled by selecting the concentration of the dope, the flow rate of the pump, the opening slit gap of the die, the pressure of the extrusion from the die, and the speed of the casting support. Further, the thickness is preferably controlled to be uniform such that a thickness detecting means is used to obtain a thickness information, and the information is fed back to the above apparatus.

### 3. Stretching

The film obtained by the solution or melt film forming method is transversely or longitudinally stretched under the conditions described below.

### (Longitudinal Stretching)

The longitudinal stretching is carried out according to the method of the present invention. The stretching magnification of the longitudinal stretching is preferably 1.01 to 3, more preferably 1.03 to 2.2, further preferably 1.05 to 1.5. In the present invention, the stretching magnification is obtained using the following equation.

Stretching magnification={(Length after stretching)−(Length before stretching)}/(Length before stretching)

The stretching temperature is preferably Tg−10° C. to Tg+50° C., more preferably Tg−5° C. to Tg+40° C., further preferably Tg to Tg+20° C.

### (Transverse Stretching)

The preheating step is preferably carried out before the transverse stretching. The preheating temperature is higher than the stretching temperature preferably by 1° C. to 50° C., more preferably by 3° C. to 40° C., further preferably by 5° C. to 30° C., particularly preferably by 10° C. to 30° C. The preheating time is preferably 1 second to 10 minutes, more preferably 5 seconds to 4 minutes, further preferably 10 seconds to 2 minutes. In the preheating step, the width of a tenter is preferably kept approximately constant. The term “approximately constant” means that the tenter width is kept within the error range of ±10% of the unstretched film width.

The transversely stretching may be performed by using a tenter. Thus, the both width direction ends of the film are held with clips, and the film is stretched in the transverse direction. The stretching temperature may be controlled by blowing air with a desired temperature into the tenter. The stretching temperature is preferably (Tg−10)° C. to (Tg+

60)° C., more preferably (Tg−5)° C. to (Tg+45)° C., further preferably Tg to (Tg+30)° C. The stretching magnification is preferably 1.01 to 3, more preferably 1.03 to 2.5, further preferably 1.05 to 2.3.

The heat-fixing temperature is preferably lower than the stretching temperature preferably by 1° C. to 50° C., more preferably by 3° C. to 40° C., further preferably by 5° C. to 30° C., particularly preferably by 10° C. to 30° C. It is further preferred that the heat-fixing temperature is equal to or lower than the stretching temperature and equal to or lower than Tg. The preheating time is preferably 1 second to 10 minutes, more preferably 5 seconds to 4 minutes, further preferably 10 seconds to 2 minutes. In the heat-fixing step, the width of the tenter is preferably kept approximately constant. The term “approximately constant” means that the tenter width is kept within the error range of 0% to −10% of the tenter width after the stretching. Thus, it is preferred that the tenter width in the heat-fixing step is equal to the tenter width after the stretching or reduced therefrom by 10% or less. When the tenter width is larger than this range, a residual strain may be increased in the film, so that the Re and Rth changes with time may be increased disadvantageously.

As described above, the inequality of [the heat-fixing temperature<the stretching temperature<the preheating temperature] is preferably satisfied.

The advantageous effects of the present invention can be obtained even in rapid stretching. In the transverse stretching step, the transporting speed (in the longitudinal direction) is preferably 20 m/minute or more, more preferably 25 m/minute or more, further preferably 30 m/minute or more. Even in such a rapid transverse stretching, the advantageous effects of the present invention can be obtained significantly.

### (Relaxation Treatment)

The relaxation treatment may be carried out under the above conditions after the stretching step to improve the dimension stability. The thermal relaxation is preferably carried out after the longitudinal stretching and/or after the transverse stretching, and is more preferably carried out after the transverse stretching. The relaxation treatment may be carried out online successively after the stretching, and may be carried out offline after winding the stretched film.

### (Order of Stretching)

The longitudinal stretching, the transverse stretching, and the relaxation treatment may be carried out in any combination and in any order. For example, the steps may be carried out in the following combination.

(a) Transverse stretching
(b) Transverse stretching→Relaxation treatment
(c) Longitudinal stretching→Transverse stretching
(d) Longitudinal stretching→Transverse stretching→Relaxation treatment
(e) Longitudinal stretching→Relaxation treatment→Transverse stretching→Relaxation treatment
(f) Transverse stretching→Longitudinal stretching→Relaxation treatment
(g) Transverse stretching→Relaxation treatment→Longitudinal stretching→Relaxation treatment
(h) Longitudinal stretching→Transverse stretching→Longitudinal stretching
(i) Longitudinal stretching→Transverse stretching→Longitudinal stretching→Relaxation treatment

The combinations of (a) to (d) are more preferred, and the combinations of (b) and (d) are further preferred.

Thus obtained film preferably has the following physical properties.

### (Physical Properties of Stretched Film)

The Re and the Rth of the cellulose acylate film obtained by the longitudinal stretching step, the transverse stretching step, or the longitudinal and transverse stretching steps preferably satisfy the following inequalities (R-1) and (R-2).

0 nm≦Re≦200 nm Inequality (R-1)

0 nm≦Rth≦600 nm Inequality (R-2)

In the inequalities, Re represents an in-plane retardation of the cellulose acylate film, and Rth represents a retardation in the thickness direction of the cellulose acylate film.

The Re and the Rth more preferably satisfy the inequalities of 180≧Re≧10 and 400≧Rth≧50, further preferably satisfy the inequalities of 150≧Re≧20 and 300≧Rth≧100.

Further, the angle θ between the film forming direction (the longitudinal direction) and the Re slow axis of the film is preferably close to 0°, +90°, or −90°. In the case of using the longitudinal stretching step, the angle θ is preferably close to 0°, more preferably 0±3°, further preferably 0±2°, still further preferably 0±1°. In the case of using the transverse stretching step, the angle θ is preferably 90±3° or −90±3°, more preferably 90±2° or −90±2°, further preferably 90±1° or −90±1°.

The in-plane distributions of the Re and the Rth are preferably 0% to 8%, more preferably 0% to 5%, further preferably 0% to 3%. Each of the distributions is obtained on percentage such that the Re or the Rth of the film surface is measured, and the difference between the maximum and minimum values is divided by the average value.

The Re and Rth changes during storage (at 80° C., for 500 hours, the details will be described hereinafter) are preferably 0% to 8%, more preferably 0% to 6%, further preferably 0% to 4%.

The in-plane distribution of the optical elasticity is preferably 0.1% to 10%, more preferably 0.2% to 8%, further preferably 0.3% to 5%. The distribution is obtained on percentage such that the Re or the Rth of the film surface is measured, and the difference between the maximum and minimum values is divided by the average value.

The thickness of the stretched cellulose acylate film is preferably 20 to 100 μm, more preferably 25 to 85 μm, further preferably 30 to 60 μm. The thickness unevenness is preferably 0% to 3%, more preferably 0% to 2%, further preferably 0% to 1%, in both the longitudinal direction and the width direction. By reducing the thickness of the film, the residual strain in the stretched film can be reduced, and the retardation changes with time can be reduced. When the thickness is larger, the inside of the stretched film is cooled more slowly than the surface of the film, so that a residual strain is increased due to thermal shrinkage difference.

The thermal dimensional change rate of the cellulose acylate film (at 80° C., dry condition, for 5 hours) is preferably 0% to 0.5%, more preferably 0% to 0.3%, further preferably 0% to 0.2%.

### <Modification of Cellulose Acylate Film of Present Invention>

The cellulose acylate film of the present invention may be used singly, and may be used in combination with a polarizing plate. A liquid crystal layer, a layer with a controlled refractive index (such as a low-reflection layer), or a hard coat layer may be formed on the cellulose acylate film. Thus, the cellulose acylate film may be modified as follows.

### (Surface Treatment)

The cellulose acylate film may be surface-treated to improve the adhesion to a functional layer such as an undercoat layer or a back layer. Examples of the surface treatments include glow discharge treatments, ultraviolet irradiation treatments, corona treatments, flame treatments, and acid or alkali treatments. The glow discharge treatments include low-temperature plasma treatments under a low-pressure gas at 10⁻³ to 20 Torr (0.13 to 2700 Pa). Further, the glow discharge treatments include plasma treatments at atmosphere pressure.

A plasma excitation gas causes plasma excitation under the above conditions, and examples thereof include argon, helium, neon, krypton, xenon, nitrogen, carbon dioxide, freons such as tetrafluoromethane, and mixtures thereof. The plasma excitation gas is described in detail in Kokai Giho (JIII Journal of Technical Disclosure), No. 2001-1745, published on Mar. 15, 2001, Japan Institute of Invention and Innovation, Page 30 to 32. The plasma treatments at atmospheric pressure have recently been attracting much attention. For example, the treatments may be carried out at 10 to 1000 keV under an irradiation energy of 20 to 500 kGy, more preferably at 30 to 500 keV under an irradiation energy of 20 to 300 kGy.

Among the above treatments, the alkali saponification treatments are particularly preferred.

In the alkali saponification treatment, the cellulose acylate film may be soaked in a saponification liquid (a dipping method), and may be coated with a saponification liquid (a coating method). In the dipping method, the cellulose acylate film is soaked for 0.1 to 10 minutes in a bath containing an aqueous solution of NaOH, KOH, etc. having a pH of 10 to 14 heated at 20° C. to 80° C., and then neutralized, water-washed, and dried.

Examples of the coating methods include dip coating methods, curtain coating methods, extrusion coating methods, bar coating methods, and E-coating methods. It is preferred that a solvent in a coating liquid for the alkali saponification treatment shows an excellent wetting property and does not form a concave-convex structure on the surface of the transparent support, maintaining the excellent surface state of the transparent support even after the application to the transparent support. Specifically, the solvent is preferably an alcohol-based solvent, particularly preferably isopropyl alcohol. Further, an aqueous solution of a surfactant may be used as the solvent. An alkali in the coating liquid for the alkali saponification treatment is preferably soluble in the solvent, and is further preferably KOH or NaOH. The pH of the coating liquid for the alkali saponification treatment is preferably 10 or more, more preferably 12 or more. The reaction time of the alkali saponification is preferably 1 second to 5 minutes, more preferably 5 seconds to 5 minutes, particularly preferably 20 seconds to 3 minutes, at room temperature. After the alkali saponification reaction, the surface coated with the saponification liquid is preferably water-washed, or washed with acid and water successively. The saponification treatment using the coating method and the coating of the oriented film may be carried out successively to reduce the number of steps. These saponification methods are described specifically in Japanese Laid-Open Patent Publication No. 2002-82226, WO 02/46809, etc.

The undercoat layer is preferably formed to improve the adhesion between the cellulose acylate film and the functional layer. This layer may be formed after the surface treatment, and may be formed without the surface treatment. The undercoat layer is described in detail in Kokai Giho (JIII Journal of Technical Disclosure), No. 2001-1745, published on Mar. 15, 2001, Japan Institute of Invention and Innovation, Page 32.

The steps of the surface treatment and the undercoating may be carried out as the final steps of the film forming process, and may be carried out separately from the film forming process. Further, the steps may be carried out in the step of forming the functional layer to be hereinafter described.

### (Formation of Functional Layer)

The cellulose acylate film of the present invention is preferably used in combination with the functional layer, which is described in detail in Kokai Giho (JIII Journal of Technical Disclosure), No. 2001-1745, published on Mar. 15, 2001, Japan Institute of Invention and Innovation, Page 32 to 45. The cellulose acylate film is particularly preferably used in combination with a polarizing layer (a polarizing plate), an optical compensatory layer (an optical compensatory sheet), or an antireflection layer (an antireflection film).

Measurement methods used in the present invention will be described below.

### (1) Nip Pressure

The nip pressure is measured at 25° C. using pressure measuring films PRESCALE available from FUJIFILM Corporation (a film for super-ultralow pressure of less than 0.5 MPa, a film for ultralow pressure of at least 0.5 MPa and less than 2.5 MPa, a film for low pressure of at least 2.5 MPa and less than 10 MPa, and a film for medium pressure of 10 MPa or more), an exclusive concentration meter FPD-305E manufactured by FUJIFILM Corporation, and a pressure conversion device FPD-306E.

### (2) Glass Transition Temperature (Tg)

20 mg of a sample is added to a measuring pan of a differential scanning calorimeter (DSC). The sample is heated from 30° C. to 250° C. at 10° C./minute under nitrogen flow (1st-run), cooled to 30° C. at 10° C./minute, and then reheated from 30° C. to 250° C. (2nd-run). A temperature, at which a baseline begins to be shifted from the low temperature side in the 2nd-run, is measured as the glass transition temperature (Tg).

### (3) Re, Rth, ΔRe, ΔRth

A sample film is left under conditions of 25° C. and a relative humidity 60% for 5 hours or more, and retardation values of the sample film are measured under the same conditions at a wavelength of 550 nm from a direction perpendicular to the sample film surface and directions tilted at ±40° to the film surface normal line by using an automatic birefringence meter KOBRA-21ADH manufactured by Oji Scientific Instruments. The in-plane retardation (Re) is obtained from the retardation value from the perpendicular direction, and the thickness direction retardation (Rth) is calculated from the retardation values from the perpendicular direction and the ±400 tilt directions.

The same procedures are carried out also under conditions of 25° C. and a relative humidity 10% and conditions of 25° C. and a relative humidity 80%, to obtain Re(10), Rth(10), Re(80), and Rth(80). The retardation changes due to humidity (ΔRe and ΔRth) are obtained using the following equations.

ΔRe=|Re(10)−Re(80)|/Re

ΔRth=|Rth(10)−Rth(80)|/Rth

### (4) Unevennesses of ΔRe and ΔRth

100 samples are cut out in the longitudinal direction, and 50 samples are cut out in the width direction as described below. The samples are subjected to the above measurement of ΔRe and ΔRth. The ΔRe unevenness (distribution) and the ΔRth unevenness (distribution) of each of the 100 longitudinal direction samples and the 50 width direction samples are obtained on percentage such that the difference between the maximum and minimum values of the ΔRe or ΔRth is divided by the average value.

(a) Sampling in MD (longitudinal direction): 100 areas arranged on the film in 20 rows and 5 columns are selected, and 100 samples with 1-square-cm size are cut out from the areas. The 20 rows are arranged in the longitudinal direction at an interval of 0.5 m. One of the columns is at the width direction center, other two thereof are arranged in the width direction at a distance of the width×0.2 from the center, and the other two are arranged in the width direction at a distance of the width×0.4 from the center.

(b) Sampling in TD (width direction): 50 areas arranged on the film in the width direction at a regular interval are selected (the entire film width being equally divided by the 50 areas), and 50 samples with 1-square-cm size are cut out from the areas.

### (5) Substitution Degree of Cellulose Acylate

The acyl substitution degree of the cellulose acylate is obtained using ¹³C-NMR by a method described in Tezuka, et al., Carbohydr. Res., 273 (1995) 83-91.

### (6) Residual Solvent Content

Residual solvent content (%)=(M−N)/N×100

In the equation, M represents the mass of the film before heating, and N represents the mass after heating the film having the mass M at 110° C. for 3 hours.

### (7) Dimensional Change Due to Heat and Humidity

(a) MD samples are cut out from the film at a width direction interval of 5 cm and a regular longitudinal direction length of 25 cm, and TD samples are cut out from the film at a regular width direction interval of 25 cm and a regular longitudinal direction length of 5 cm, over the entire film width.

(b) Each sample is left under conditions of 25° C. and a relative humidity 60% for 2 hours or more, and then the length L1 of the sample is measured under the same conditions using a 20-cm-long pin gage.

(c) The sample is thermally treated with no tension for 1 day under conditions of 40° C. and a relative humidity 95%. The conditions of 40° C. and a relative humidity 95% are remarkably more effective for dimensionally changing the sample, as compared with conditions of 40° C. and a relative humidity 90%.

(d) After thermal treatment, the sample is left under conditions of 25° C. and a relative humidity 60% for 3 hours or more, and then the length L2 of the sample is measured under the same conditions using a 20-cm-long pin gage.

(e) ΔL of all samples including the MD samples and the TD samples are calculated using the following equation, and the obtained maximum value is obtained as the dimensional change due to heat and humidity.

ΔL=100×|L2−L1/L1

A specific embodiment of the present invention will be described in detail below without intention of restricting the scope of the invention.

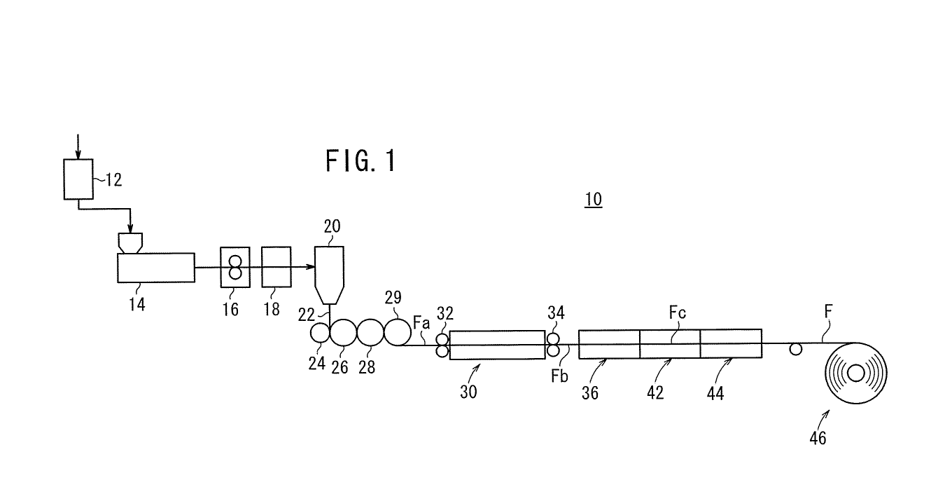

FIG. 1 is a schematic structural view showing a film producing apparatus 10 for producing a cellulose acylate film according to the embodiment of the present invention using a melt film forming method.

The film producing apparatus 10 shown in FIG. 1 is capable of producing a cellulose acylate film F useful for a liquid crystal display device, etc. A cellulose acylate resin pellet, a material for the cellulose acylate film F, is introduced to a dryer 12, and dried therein. The dried pellet is extruded by an extruder 14, and transported to a filter 18 by a gear pump 16. A contaminant in the pellet is removed by filtration with the filter 18, and a resin melt 22 of the cellulose acylate resin is extruded from a die 20. Then, the resin melt 22 is nipped between a first cooling roll 26 and a touch roll 24, and cooled and solidified on the first cooling roll 26 to prepare a film-shaped melt having a predetermined surface roughness. The film-shaped melt is transported by a second cooling roll 28 and a third cooling roll 29, to obtain an unstretched film Fa. The unstretched film Fa may be then wound and removed. Alternatively, the unstretched film Fa may be successively introduced to a longitudinal stretching portion 30 for long-span stretching. Even in a case where the unstretched film Fa is once wound and removed, and then introduced to the longitudinal stretching portion 30, the advantageous effects of the present invention are achieved.

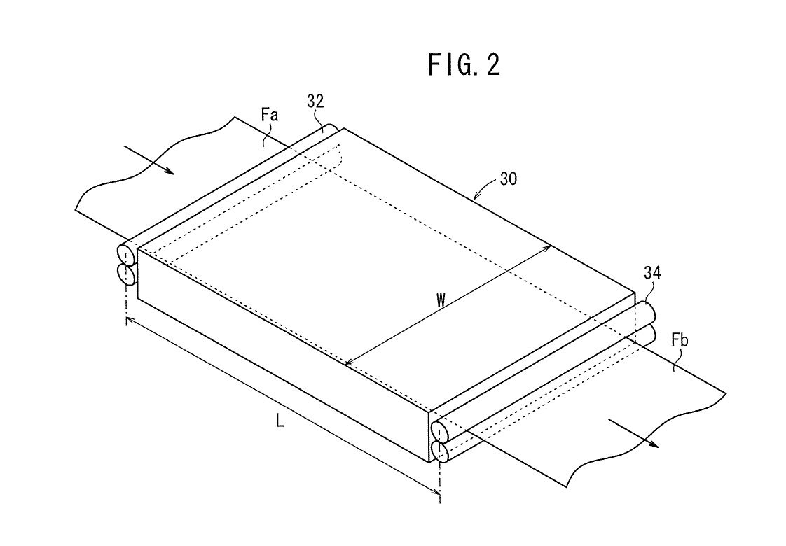

In the longitudinal stretching portion 30, the unstretched film Fa is stretched in the transporting direction between entry-side nip rolls 32 and exit-side nip rolls 34, to prepare a longitudinally stretched film Fb. FIG. 2 is a perspective explanatory view showing the longitudinal stretching portion 30, and the length/width ratio (L/W) of the longitudinal stretching is determined depending on the distance L between the entry-side nip rolls 32 and the exit-side nip rolls 34, and the width W of the entry-side nip rolls 32 and the exit-side nip rolls 34 in the length directions. The longitudinally stretched film Fb is transported through a preheating portion 36 and controlled at a preheating temperature, and then introduced to a transversely stretching portion 42.

In the transversely stretching portion 42, as shown in FIG. 1, the longitudinally stretched film Fb is stretched in the width direction perpendicular to the transporting direction to prepare a transversely stretched film Fc. The transversely stretched film Fc is introduced to a heat-fixing portion 44, and wound in a winding portion 46. Thus, the final product of the cellulose acylate film F having controlled orientation angle and retardations is produced. The transversely stretched film Fc may be subjected to a thermal relaxation treatment after passing the heat-fixing portion 44. The preheating portion 36 acts as the preheating zone in which the longitudinally stretched film Fb is preheated, the transversely stretching portion 42 acts as the transversely stretching zone in which the longitudinally stretched, preheated film Fb is transversely stretched, and the heat-fixing portion 44 acts as the heat-fixing zone in which the transversely stretched film Fc is heat-fixed. When the preheating zone length is the length of the preheating zone in the direction of transporting the longitudinally stretched film Fb, and the transversely stretching zone length is the length of the transversely stretching zone in the direction of transporting the longitudinally stretched film Fb, the ratio of the preheating zone length/the transversely stretching zone length is preferably 0.1 to 10. Further, when the heat-fixing zone length is the length of the heat-fixing zone in the direction of transporting the transversely stretched film Fc, the ratio of the heat-fixing zone length/the transversely stretching zone length is preferably 0.1 to 10.

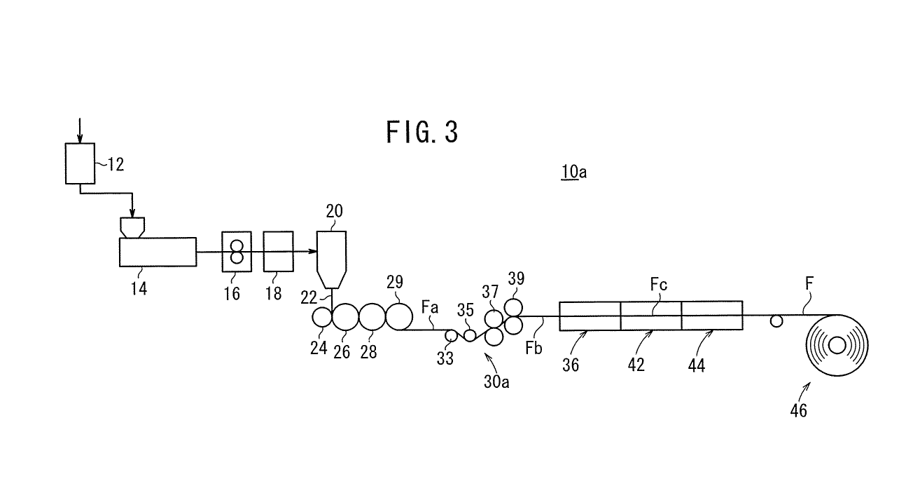

FIG. 3 is a schematic structural view showing a film producing apparatus 10a according to a modification embodiment of the present invention using a longitudinal stretching portion 30a for short-span stretching instead of the longitudinal stretching portion 30 for long-span stretching of FIG. 1.

In the film producing apparatus 10a, the unstretched film Fa is preheated at a predetermined temperature by preheating rolls 33, 35, transported to two pairs of nip rolls 37, 39, and longitudinally stretched thereby. In this embodiment, the nip rolls 37, 39 are arranged in the vicinity in the direction of transporting the unstretched film Fa at a distance in the vertical direction. By arranging the nip rolls 37, 39 in this manner, the distance of transporting the unstretched film Fa in the longitudinal stretching portion 30a can be reduced to achieve the short-span stretching.

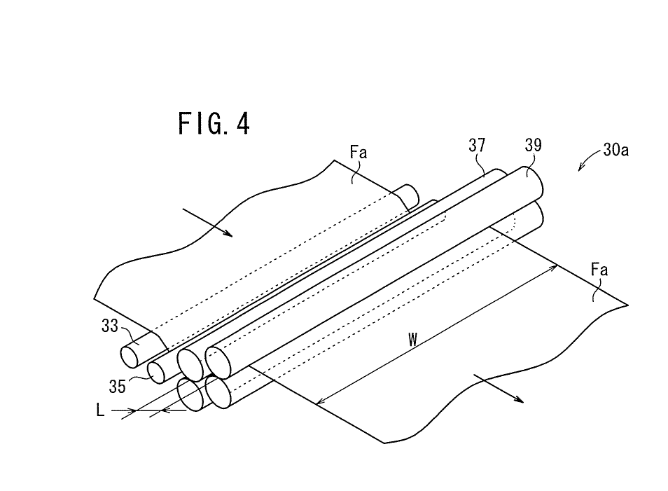

FIG. 4 is a perspective explanatory view showing the longitudinal stretching portion 30a, and the length/width ratio (L/W) of the longitudinal stretching is determined depending on the distance L between the nip rolls 37, 39 in the direction of transporting the unstretched film Fa, and the width W of the nip rolls 37, 39 in the length directions.

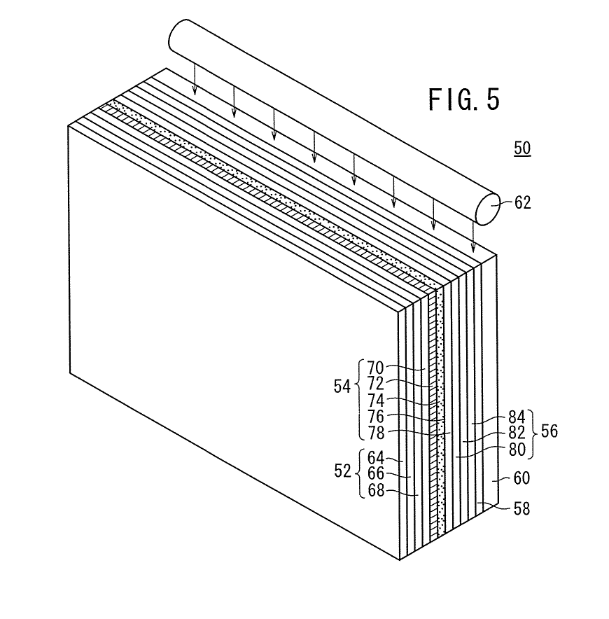

FIG. 5 is a schematic structural view showing a liquid crystal display device 50 using the cellulose acylate film F produced in the above manner.

In the liquid crystal display device 50, a polarizing plate 52, a liquid crystal cell 54, and a polarizing plate 56 are stacked in this order, and a light guide plate 60 is attached to the polarizing plate 56 with a diffuser plate 58 disposed therebetween. An illumination light is introduced from a backlight 62 into the light guide plate 60.

The polarizing plate 52 is formed by sandwiching a polarizer 66 between an antireflection film 64 and an optical compensatory film 68. The liquid crystal cell 54 has a color filter 72 having R, G, B pixels attached to a glass substrate 70, and to a liquid crystal layer 74, a TFT layer 76, and a glass substrate 78 are formed on the liquid crystal layer 74 in this order. The polarizing plate 56 is formed by sandwiching a polarizer 82 between an optical compensatory film 80 and a protective film 84.

In this embodiment, the cellulose acylate film F produced by the film producing apparatus 10, 10a shown in FIGS. 1 and 3 can be used as the antireflection film 64, the optical compensatory film 68, 80, or the protective film 84 in the liquid crystal display device 50.

Without departing from the scope of the present invention, the present invention may be combined with technologies disclosed in the following patent documents:

Japanese Laid-Open Utility Model Publication No. 3-110418; Japanese Laid-Open Patent Publication Nos. 5-119216, 5-162261, 5-182518, 5-19115, 5-196819, 5-264811, 5-281411, 5-281417, 5-281537, 5-288921, 5-288923, 5-311119, 5-339395, 5-40204, 5-45512, 6-109922, 6-123805, 6-160626, 6-214107, 6-214108, 6-214109, 6-222209, 6-222353, 6-234175, 6-235810, 6-258520, 6-264030, 6-305270, 6-331826, 6-347641, 6-75110, 6-75111, 6-82779, 6-93133, 7-104126, 7-134212, 7-181322, 7-188383, 7-230086, 7-290652, 7-294903, 7-294904, 7-294905, 7-325219, 7-56014, 7-56017, 7-92321, 8-122525, 8-146220, 8-171016, 8-188661, 8-21999, 8-240712, 8-25575, 8-286179, 8-292322, 8-297211, 8-304624, 8-313881, 8-43812, 8-62419, 8-62422, 8-76112, 8-94834, 9-137143, 9-197127, 9-251110, 9-258023, 9-269413, 9-269414, 9-281483, 9-288212, 9-288213, 9-292525, 9-292526, 9-294959, 9-318817, 9-80233, 10-10320, 10-104428, 10-111403, 10-111507, 10-123302, 10-123322, 10-123323, 10-176118, 10-186133, 10-264322, 10-268133, 10-268134, 10-319408, 10-332933, 10-39137, 10-39140, 10-68821, 10-68824, 10-90517, 11-116903, 11-181131, 11-211901, 11-211914, 11-242119, 11-246693, 11-246694, 11-256117, 11-258425, 11-263861, 11-287902, 11-295525, 11-295527, 11-302423, 11-309830, 11-323552, 11-335641, 11-344700, 11-349947, 11-95011, 11-95030, 11-95208, 2000-109780, 2000-110070, 2000-119657, 2000-141556, 2000-147208, 2000-17099, 2000-171603, 2000-171618, 2000-180615, 2000-187102, 2000-187106, 2000-191819, 2000-191821, 2000-193804, 2000-204189, 2000-206306, 2000-214323, 2000-214329, 2000-230159, 2000-235107, 2000-241626, 2000-250038, 2000-267095, 2000-284122, 2000-304927, 2000-304928, 2000-304929, 2000-309195, 2000-309196, 2000-309198, 2000-309642, 2000-310704, 2000-310708, 2000-310709, 2000-310710, 2000-310711, 2000-310712, 2000-310713, 2000-310714, 2000-310715, 2000-310716, 2000-310717, 2000-321560, 2000-321567, 2000-338309, 2000-338329, 2000-344905, 2000-347016, 2000-347017, 2000-347026, 2000-347027, 2000-347029, 2000-347030, 2000-347031, 2000-347032, 2000-347033, 2000-347034, 2000-347035, 2000-347037, 2000-347038, 2000-86989, 2000-98392, 2001-100012, 2001-108805, 2001-108806, 2001-133627, 2001-133628, 2001-142062, 2001-142072, 2001-174630, 2001-174634, 2001-174637, 2001-179902, 2001-183526, 2001-188103, 2001-188124, 2001-188125, 2001-188225, 2001-188231, 2001-194505, 2001-228311, 2001-228333, 2001-242461, 2001-242546, 2001-247834, 2001-26061, 2001-264517, 2001-272535, 2001-278924, 2001-2797, 2001-287308, 2001-305345, 2001-311827, 2001-350005, 2001-356207, 2001-356213, 2001-42122, 2001-42323, 2001-42325, 2001-4819, 2001-4829, 2001-4830, 2001-4831, 2001-4832, 2001-4834, 2001-4835, 2001-4836, 2001-4838, 2001-4839, 2001-51118, 2001-51119, 2001-51120, 2001-51273, 2001-51274, 2001-55573, 2001-66431, 2001-66597, 2001-74920, 2001-81469, 2001-83329, 2001-83515, 2002-162628, 2002-169024, 2002-189421, 2002-201367, 2002-20410, 2002-258046, 2002-275391, 2002-294174, 2002-311214, 2002-311246, 2002-328233, 2002-338703, 2002-363266, 2002-365164, 2002-370303, 2002-40209, 2002-48917, 2002-6109, 2002-71950, 2003-105540, 2003-114331, 2003-131036, 2003-139952, 2003-172819, 2003-35819, 2003-43252, 2003-50318, and 2003-96066;

Japanese Laid-Open Patent Publication Nos. 2006-45501, 2006-45502, 2006-45499, 2006-45500, 2006-182008, 2006-241433, 2006-348123, 2005-325258, 2006-2026, 2006-2025, 2006-183005, 2006-183004, 2006-143873, 2006-257204, 2006-205472, 2006-241428, 2006-251746, 2007-1198, and 2007-1238; WO 2005/103122; Japanese Laid-Open Patent Publication Nos. 2006-176736, 2006-243688, 2006-327105, 2006-124642, 2006-205708, 2006-341443, 2006-199913, 2006-335050, 2007-8154, 2006-334840, 2006-341450, 2006-327162, 2006-341510, 2006-327161, 2006-327107, 2006-327160, 2006-328316, 2006-334839, 2007-8151, 2007-1286, 2006-327106, 2006-334841, 2006-334842, 2005-330411, 2006-116945, 2005-301225, 2007-1287, and 2006-348268; WO 2006/132367; Japanese Laid-Open Patent Publication Nos. 2005-178194, 2006-336004, 2006-249418, 2007-2216, 2006-28345, 2006-215535, 2006-28387, 2007-2215, 2006-343479, and 2006-263992; and

Japanese Laid-Open Patent Publication Nos. 2000-352620, 2005-088578, 2005-300978, 2005-342929, 2006-021459, 2006-030425, 2006-036840, 2006-045306, 2006-045307, 2006-058825, 2006-063169, 2006-77067, 2006-77113, 2006-82261, 2006-91035, 2006-91078, 2006-104374, 2006-106247, 2006-111796, 2006-111797, 2006-113175, 2006-113551, 2006-113567, 2006-116904, 2006-117714, 2006-119182, 2006-119183, 2006-123513, 2006-123177, 2006-124629, 2006-137821, 2006-142800, 2006-163033, 2006-163034, 2006-171404, 2006-178020, 2006-182020, 2006-182865, 2006-188663, 2006-195407, 2006-208934, 2006-219615, 2006-220814, 2006-224589, 2006-249221, 2006-256082, 2006-272616, 2006-290929, 2006-293201, 2006-301500, and 2006-301592.

### Examples 1 to 22 and Comparative Examples 1 to 11

### Solution Cast Film Forming

### (Production and Evaluation of Cellulose Acylate Film)

The following composition was added to a pressure tight vessel and heated to 80° C. The internal pressure of the vessel was increased to 500 kPa, and the composition was completely dissolved while stirring and keeping the temperature.

| | | |
|---|---|---|
| Cellulose acetate propionate (CAP having | 120% | by mass |
| substitution degrees shown in Tables | | |
| 1-1 and 1-2) | | |
| 2-(2′-Hydroxy-3′,5′-di-t-butyl- | 1% | by mass |
| phenyl)benzotriazole (ultraviolet absorber) | | |
| Ethyl phthalyl ethyl glycolate (EPEG, | | |
| plasticizer, added in an amount shown | | |
| in Tables 1-1 and 1-2) | | |
| Fine silica particles (AEROSIL 200 | 0.1% | by mass (0.016 μm) |
| available from Nippon Aerosil Co., Ltd.) | | |
| Dichloromethane | 450% | by mass |
| Ethanol | 50% | by mass |

The obtained dope was cooled to 40° C., and the internal pressure of the vessel was returned to ordinary pressure. The dope was left under the conditions overnight, and then defoamed. The resultant solution was subjected to a filtration using a paper filter Azumi No. 244 manufactured by Azumi Filterpaper Co., Ltd. Then, the dope was cooled to and maintained at 35° C., and uniformly cast on an endless, rotatable, stainless belt having a length of 6 m (an effective length of 5.5 m) and a thickness shown in Tables 1-3 and 1-4, which was attached onto two drums. Warm water at 35° C. was brought in contact with the back side of the stainless belt to dry the dope for 2 minutes, and then cold water at 15° C. was brought in contact with the back side. The solvent was vaporized such that the cast film had a residual solvent content of 20%, and the film was peeled from the stainless belt under a peeling tension of 150 N/m. The peeled film was dried at 130° C. while fixing the both ends, and further dried while transporting the film by a plurality of rolls under a transporting tension of 130 N/m, to obtain a film having a thickness of 120 μm (a film of Example 1).

Films of Examples 2 to 22 and Comparative Examples 1 to 11 were produced respectively in the same manner as Example 1 except for changing the cellulose material, the type and amount of the solvent, the plasticizer, the residual solvent content, and the film thickness as shown in Tables 1-1 to 1-8.

The plasticizers A, B, C, and D used in Examples 1 to 22 and Comparative Examples 1 to 11 are the following compounds.

Plasticizer A: Ethyl phthalyl ethyl glycolate

Plasticizer B: Trimethylolpropane tribenzoate

Plasticizer C: 1,2-Propanediol dibenzoate

Plasticizer D:

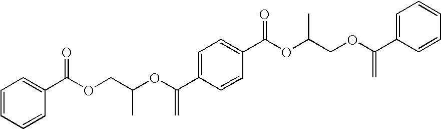

Each of the produced films was stretched under conditions shown in Tables 1-3 to 1-6, and the above described measurement and evaluation were carried out. The results are shown in Tables 1-7 and 1-8. The longitudinal stretching was carried out at the same temperature as the transverse stretching in each example.

TABLE 1-1
Solution film forming method

| | Cellulose acylate | | | Plasticizer | |
|---|---|---|---|---|---|
| | X | Y | Number average | | Amount |
| | Acetyl | Propionyl | molecular weight | | (% |
| | group | group | (ten thousand) | Type (ratio) | by mass) |
| Comparative | 2 | 0.8 | 10 | EPEG | 0 |
| Example 1 | | | | | |
| Example 1 | 2 | 0.8 | 10 | EPEG | 2 |
| Example 2 | 2 | 0.8 | 10 | EPEG | 10 |
| Example 3 | 2 | 0.8 | 10 | EPEG | 18 |
| Comparative | 2 | 0.8 | 10 | EPEG | 22 |
| Example 2 | | | | | |
| Comparative | 1.89 | 0.68 | 11 | A/B (13.5/5.5) | 19 |
| Example 3 | | | | | |
| Example 4 | 1.89 | 0.68 | 11 | A/B (13.5/5.5) | 19 |
| Comparative | 1.54 | 0.84 | 12 | B/C/D (4.9/2.3/1.4) | 8.6 |
| Example 4 | | | | | |
| Example 5 | 1.54 | 0.84 | 12 | B/C/D (4.9/2.3/1.4) | 8.6 |
| Example 6 | 1.54 | 0.84 | 12 | B/C/D (4.9/2.3/1.4) | 8.6 |
| Comparative | 1.54 | 0.84 | 12 | B/C/D (4.9/2.3/1.4) | 8.6 |
| Example 5 | | | | | |
| Comparative | 1.89 | 0.68 | 10 | TPP/A (8.8/2.2) | 11 |
| Example 6 | | | | | |
| Example 7 | 1.89 | 0.68 | 10 | TPP/A (8.8/2.2) | 11 |
| Example 8 | 1.89 | 0.68 | 10 | TPP/A (8.8/2.2) | 11 |
| Example 9 | 1.89 | 0.68 | 10 | TPP/A (8.8/2.2) | 11 |
| Example 10 | 1.89 | 0.68 | 10 | TPP/A (8.8/2.2) | 11 |
| Comparative | 1.89 | 0.68 | 10 | TPP/A (8.8/2.2) | 11 |
| Example 7 | | | | | |

TABLE 1-2
Solution film forming method

| | Cellulose acylate | | | Plasticizer | |
|---|---|---|---|---|---|
| | X | Y | Number average | | Amount |
| | Acetyl | Propionyl | molecular weight | Type | (% by |
| | group | group | (ten thousand) | (ratio) | mass) |
| Comparative | 1.5 | 1.2 | 9 | TPP | 15 |
| Example 8 | | | | | |
| Example 11 | 1.5 | 1.2 | 9 | TPP | 15 |
| Example 12 | 1.5 | 1.2 | 9 | TPP | 15 |
| Example 13 | 1.5 | 1.2 | 9 | TPP | 15 |
| Example 14 | 1.5 | 1.2 | 9 | TPP | 15 |
| Comparative | 1.5 | 1.2 | 9 | TPP | 15 |
| Example 9 | | | | | |
| Comparative | 2.3 | 0.5 | 14 | TPP | 15 |
| Example 10 | | | | | |
| Example 15 | 2.3 | 0.5 | 14 | TPP | 15 |
| Example 16 | 2.3 | 0.5 | 14 | TPP | 15 |
| Comparative | 2.3 | 0.5 | 14 | TPP | 15 |
| Example 11 | | | | | |
| Example 17 | 2 | 0.8 | 12 | EPGA | 5 |
| Example 18 | 2 | 0.8 | 12 | EPGA | 5 |
| Example 19 | 2 | 0.8 | 12 | EPGA | 5 |
| Example 20 | 2 | 0.8 | 12 | EPGA | 5 |
| Example 21 | 2 | 0.8 | 12 | EPGA | 5 |
| Example 22 | 2 | 0.8 | 12 | EPGA | 5 |

TABLE 1-3
Solution film forming method

| | | | Longitudinal stretching | | | |
|---|---|---|---|---|---|---|
| | Thickness of | Residual solvent | | | Peripheral | |
| | solution film | content before | | Nip | speed | |
| | forming belt | stretching | | pressure | difference | Stretching |
| | (mm) | (%) | L/W | (MPa) | (%) | magnification |
| Comparative | 1 | 0.1 | Not longitudinally stretched | | | |
| Example 1 | | | | | | |
| Example 1 | 1 | 0.1 | | | | |
| Example 2 | 1 | 0.1 | | | | |
| Example 3 | 1 | 0.1 | | | | |
| Comparative | 1 | 0.1 | | | | |
| Example 2 | | | | | | |
| Comparative | 0.6 | 0.3 | 0.1 | 5 | 0.02 | 1.05 |
| Example 3 | | | | | | |
| Example 4 | 0.6 | 0.3 | 0.1 | 5 | 0.02 | 1.05 |
| Comparative | 1.5 | 0 | 0.05 | 2 | 0.05 | 1.3 |
| Example 4 | | | | | | |
| Example 5 | 1.5 | 0 | 0.05 | 2 | 0.05 | 1.3 |
| Example 6 | 1.5 | 0 | 0.05 | 2 | 0.05 | 1.3 |
| Comparative | 1.5 | 0 | 0.05 | 2 | 0.05 | 1.3 |
| Example 5 | | | | | | |
| Comparative | 1.8 | 0.4 | 1.7 | 8 | 0.1 | 2.8 |
| Example 6 | | | | | | |
| Example 7 | 1.8 | 0.4 | 2 | 8 | 0.1 | 2.8 |
| Example 8 | 1.8 | 0.4 | 20 | 8 | 0.1 | 2.8 |
| Example 9 | 1.8 | 0.4 | 20 | 8 | 0 | 2.8 |
| Example 10 | 1.8 | 0.4 | 48 | 8 | 0.1 | 2.8 |
| Comparative | 1.8 | 0.4 | 52 | 8 | 0.1 | 2.8 |
| Example 7 | | | | | | |

TABLE 1-4
Solution film forming method

| | | | Longitudinal stretching | | | |
|---|---|---|---|---|---|---|
| | Thickness of | Residual solvent | | | Peripheral | |
| | solution film | content before | | Nip | speed | |
| | forming belt | stretching | | pressure | difference | Stretching |
| | (mm) | (%) | L/W | (MPa) | (%) | magnification |
| Comparative | 1.2 | 0.5 | 0.005 | 1 | 0.5 | 1.5 |
| Example 8 | | | | | | |
| Example 11 | 1.2 | 0.5 | 0.02 | 1 | 0.5 | 1.5 |
| Example 12 | 1.2 | 0.5 | 0.08 | 1 | 0.5 | 1.5 |
| Example 13 | 1.2 | 0.5 | 0.08 | 1 | 0 | 1.5 |
| Example 14 | 1.2 | 0.5 | 0.28 | 1 | 0.5 | 1.5 |
| Comparative | 1.2 | 0.5 | 0.32 | 1 | 0.5 | 1.5 |
| Example 9 | | | | | | |
| Comparative | 0.8 | 0.2 | 20 | 0.3 | 0.8 | 1.8 |
| Example 10 | | | | | | |
| Example 15 | 0.8 | 0.2 | 20 | 0.6 | 0.8 | 1.8 |
| Example 16 | 0.8 | 0.2 | 20 | 8 | 0.8 | 1.8 |
| Comparative | 0.8 | 0.2 | 20 | 12 | 0.8 | 1.8 |
| Example 11 | | | | | | |
| Example 17 | 1.2 | 0.3 | 0.05 | 3 | 0 | 1.5 |
| Example 18 | 1.2 | 0.3 | 0.05 | 3 | 0 | 1.5 |
| Example 19 | 1.2 | 0.3 | 0.05 | 3 | 0 | 1.5 |
| Example 20 | 1.2 | 0.3 | 0.05 | 3 | 0 | 1.5 |
| Example 21 | 1.2 | 0.3 | 0.05 | 3 | 1 | 1.5 |
| Example 22 | 1.2 | 2 | 0.05 | 3 | 1 | 1.5 |

TABLE 1-5
Solution film forming method

| | Preheating, transverse stretching, and heat-fixing | | | | | | | |
|---|---|---|---|---|---|---|---|---|
| | Zone temperature | | | Zone length ratio | | | Thermal relaxation | |
| | Preheating | Stretching | Heat-fixing | Preheating/ | Heat-fixing/ | Stretching | Temperature | Tension |
| | (° C.) | (° C.) | (° C.) | stretching | stretching | magnification | (° C.) | (kg/cm²) |
| Comparative | 130 | 120 | 110 | 2 | 2 | 2 | Tg + 10 | 5 |
| Example 1 | | | | | | | | |
| Example 1 | 130 | 120 | 110 | 2 | 2 | 2 | Tg + 10 | 5 |
| Example 2 | 130 | 120 | 110 | 2 | 2 | 2 | Tg + 10 | 5 |
| Example 3 | 130 | 120 | 110 | 2 | 2 | 2 | Tg + 10 | 5 |
| Comparative | 130 | 120 | 110 | 2 | 2 | 2 | Tg + 10 | 5 |
| Example 2 | | | | | | | | |
| Comparative | 140 | 150 | 150 | 6 | 4 | 2.8 | Tg | 3 |
| Example 3 | | | | | | | | |
| Example 4 | 150 | 140 | 150 | 6 | 4 | 2.8 | Tg | 3 |
| Comparative | 140 | 130 | 120 | 0.05 | 0.5 | 2 | Tg − 10 | 10 |
| Example 4 | | | | | | | | |
| Example 5 | 140 | 130 | 120 | 0.2 | 0.5 | 2 | Tg − 10 | 10 |
| Example 6 | 140 | 130 | 120 | 9 | 0.5 | 2 | Tg − 10 | 10 |
| Comparative | 140 | 130 | 120 | 12 | 0.5 | 2 | Tg − 10 | 10 |
| Example 5 | | | | | | | | |

| | | | |
|---|---|---|---|
| Comparative | Not transversely stretched | Tg + 5 | 7 |
| Example 6 | | | |
| Example 7 | | Tg + 5 | 7 |
| Example 8 | | Tg + 5 | 7 |
| Example 9 | | Tg + 5 | 7 |
| Example 10 | | Tg + 5 | 7 |
| Comparative | | Tg + 5 | 7 |
| Example 7 | | | |

TABLE 1-6
Solution film forming method

| | Preheating, transverse stretching, and heat-fixing | | | | | | | |
|---|---|---|---|---|---|---|---|---|
| | Zone temperature | | | Zone length ratio | | | Thermal relaxation | |
| | Preheating | Stretching | Heat-fixing | Preheating/ | Heat-fixing/ | Stretching | Temperature | Tension |
| | (° C.) | (° C.) | (° C.) | stretching | stretching | magnification | (° C.) | (kg/cm²) |
| Comparative | 160 | 140 | 120 | 0.5 | 3 | 1.5 | Tg − 5 | 15 |
| Example 8 | | | | | | | | |
| Example 11 | 160 | 140 | 120 | 0.5 | 3 | 1.5 | Tg − 5 | 15 |
| Example 12 | 160 | 140 | 120 | 0.5 | 3 | 1.5 | Tg − 5 | 15 |
| Example 13 | 160 | 140 | 120 | 0.5 | 3 | 1.5 | Tg − 5 | 15 |
| Example 14 | 160 | 140 | 120 | 0.5 | 3 | 1.5 | Tg − 5 | 15 |
| Comparative | 160 | 140 | 120 | 0.5 | 3 | 1.5 | Tg − 5 | 15 |
| Example 9 | | | | | | | | |
| Comparative | 170 | 130 | 120 | 4 | 1 | 1.1 | Tg + 15 | 5 |
| Example 10 | | | | | | | | |
| Example 15 | 170 | 130 | 120 | 4 | 1 | 1.1 | Tg + 15 | 5 |
| Example 16 | 170 | 130 | 120 | 4 | 1 | 1.1 | Tg + 15 | 5 |
| Comparative | 170 | 130 | 120 | 4 | 1 | 1.1 | Tg + 15 | 5 |
| Example 11 | | | | | | | | |
| Example 17 | 160 | 140 | 140 | 2 | 0.05 | 2.5 | Tg | 25 |
| Example 18 | 160 | 140 | 120 | 2 | 0.05 | 2.5 | Tg | 25 |
| Example 19 | 160 | 140 | 120 | 2 | 3 | 2.5 | Tg | 25 |
| Example 20 | 160 | 140 | 120 | 2 | 3 | 2.5 | Tg | 10 |
| Example 21 | 160 | 140 | 120 | 2 | 3 | 2.5 | Tg | 10 |
| Example 22 | 160 | 140 | 120 | 2 | 3 | 2.5 | Tg | 10 |

TABLE 1-7
Solution film forming method

| | Thickness | | Distribution of | | Distribution of | Thermal | Ratio of |
|---|---|---|---|---|---|---|---|
| | after | | Re change (ΔRe) | | Rth change (ΔRth) | shrinkage under | color |
| | stretching | Re | due to humidity | Rth | due to humidity | 40° C. and 95% rh | unevenness |
| | (μm) | (nm) | (%) | (nm) | (%) | (%) | (%) |
| Comparative | 80 | 200 | 35 | 180 | 37 | 0.19 | 40 |
| Example 1 | | | | | | | |
| Example 1 | 80 | 202 | 28 | 178 | 27 | 0.14 | 15 |
| Example 2 | 80 | 205 | 3 | 182 | 2 | 0.03 | 2 |
| Example 3 | 80 | 205 | 28 | 183 | 26 | 0.13 | 15 |
| Comparative | 80 | 203 | 35 | 176 | 36 | 0.18 | 45 |
| Example 2 | | | | | | | |
| Comparative | 60 | 230 | 34 | 260 | 35 | 0.18 | 41 |
| Example 3 | | | | | | | |
| Example 4 | 60 | 228 | 23 | 255 | 24 | 0.12 | 14 |
| Comparative | 40 | 100 | 34 | 290 | 36 | 0.19 | 42 |
| Example 4 | | | | | | | |
| Example 5 | 40 | 98 | 26 | 285 | 25 | 0.12 | 12 |
| Example 6 | 40 | 96 | 25 | 280 | 24 | 0.11 | 11 |
| Comparative | 40 | 102 | 35 | 295 | 36 | 0.17 | 40 |
| Example 5 | | | | | | | |
| Comparative | 100 | 300 | 33 | 150 | 34 | 0.18 | 43 |
| Example 6 | 100 | | | | | | |
| Example 7 | 100 | 310 | 26 | 145 | 25 | 0.11 | 12 |
| Example 8 | 100 | 305 | 3 | 140 | 2 | 0.02 | 2 |
| Example 9 | 100 | 310 | 21 | 142 | 21 | 0.1 | 9 |
| Example 10 | 100 | 305 | 24 | 140 | 24 | 0.12 | 12 |
| Comparative | 100 | 298 | 35 | 155 | 35 | 0.18 | 40 |
| Example 7 | | | | | | | |

TABLE 1-8
Solution film forming method

| | Thickness | | Distribution of | | Distribution of | Thermal | Ratio of |
|---|---|---|---|---|---|---|---|
| | after | | Re change (ΔRe) | | Rth change (ΔRth) | shrinkage under | color |
| | stretching | Re | due to humidity | Rth | due to humidity | 40° C. and 95% rh | unevenness |
| | (μm) | (nm) | (%) | (nm) | (%) | (%) | (%) |
| Comparative | 50 | 20 | 35 | 280 | 36 | 0.19 | 43 |
| Example 8 | | | | | | | |
| Example 11 | 50 | 18 | 24 | 290 | 24 | 0.12 | 10 |
| Example 12 | 50 | 18 | 3 | 282 | 2 | 0.01 | 1 |
| Example 13 | 50 | 21 | 15 | 291 | 18 | 0.08 | 6 |
| Example 14 | 50 | 22 | 23 | 285 | 24 | 0.12 | 11 |
| Comparative | 50 | 21 | 33 | 284 | 34 | 0.18 | 44 |
| Example 9 | | | | | | | |
| Comparative | 70 | 182 | 34 | 200 | 35 | 0.18 | 43 |
| Example 10 | | | | | | | |
| Example 15 | 70 | 178 | 25 | 195 | 24 | 0.13 | 12 |
| Example 16 | 70 | 186 | 24 | 205 | 23 | 0.12 | 12 |
| Comparative | 70 | 185 | 35 | 210 | 36 | 0.18 | 45 |
| Example 11 | | | | | | | |
| Example 17 | 60 | 80 | 20 | 190 | 18 | 0.09 | 8 |
| Exmaple 18 | 60 | 78 | 14 | 185 | 12 | 0.07 | 5 |
| Example 19 | 60 | 77 | 10 | 193 | 7 | 0.05 | 3 |
| Example 20 | 60 | 82 | 5 | 186 | 3 | 0.02 | 2 |
| Example 21 | 60 | 82 | 0 | 186 | 0 | 0 | 0 |
| Example 22 | 60 | 81 | 21 | 192 | 23 | 0.11 | 8 |

### (Production and Evaluation of Liquid Crystal Display Device)

Each of the obtained films was treated with a 2.5-mol/L aqueous sodium hydroxide solution at 40° C. for 60 seconds, water-washed for 3 minutes, to obtain an alkali-treated film having a saponification layer.

A 120-μm-thick polyvinyl alcohol film was soaked in 100% by mass of an aqueous solution containing 1% by mass of iodine and 4% by mass of boric acid, and stretched at 50° C. at a 4-fold magnification, to obtain a polarizing film. The above alkali-treated film was attached to each surface of the polarizing film using a bonding agent of a 5% aqueous solution of completely saponified polyvinyl alcohol, to prepare a polarizing plate. The polarizing plate was disposed on each surface of a VA-type liquid crystal cell to produce a liquid crystal display device.

The displaying unevenness due to environmental humidity change of the liquid crystal display panel was measured under the following conditions. The results are shown in Tables 1-7 and 1-8.

(a) A white color was displayed on the entire display surface of the liquid crystal display panel under conditions of 25° C. and 60% rh for 24 hours.
(b) The liquid crystal display panel was transported to a location under conditions of 25° C. and 10% rh while displaying the white color. 3 hours after the transport, the color unevenness of the display panel was measured by visual observation, and the ratio of a portion with the color unevenness to the entire display surface was obtained on percentage.

### Examples 101 to 122 and Comparative Examples 101 to 111

### Melt Film Forming Method

The following cellulose acylates were used as a polymer film material as shown in Tables 2-1 and 2-2.

### <Cellulose Acylate>

C-1: Cellulose acetate propionate (acetyl substitution degree 1.9, propionyl substitution degree: 0.8, molecular weight Mn: 70000, molecular weight Mw: 220000, Mw/Mn: 3)
C-2: Cellulose acetate propionate (CAP482-20 available from Eastman Chemical Company, acetyl substitution degree: 0.23,

propionyl substitution degree: 2.59, molecular weight Mn: 66000, molecular weight Mw: 210000)

C-3: Cellulose acetate butyrate (CAB171-15 available from Eastman Chemical Company, acetyl substitution degree: 2.0, butyryl substitution degree: 0.7, molecular weight Mn: 65000, molecular weight Mw: 190000, Mw/Mn: 3)

### <Plasticizer>

Plasticizer A: Trimethylolpropane tribenzoate (TMPB)

### Plasticizer B: Plasticizer 1 of Chemical Formula 3 of Japanese Laid-Open Patent Publication No. 2006-293201

### Plasticizer C: Plasticizer 2 of Chemical Formula 3 of Japanese Laid-Open Patent Publication No. 2006-293201

### Plasticizer D: Plasticizer 3 of Chemical Formula 3 of Japanese Laid-Open Patent Publication No. 2006-293201

Plasticizer E: 2-Ethylhexyl adipate
Plasticizer F: 1,4-Phenylene-tetraphenyl phosphate

### <Degradation Inhibitor (Antioxidant)>

IRGANOX-1010 (available from Ciba Specialty Chemicals Corporation)

### <Ultraviolet Absorber>

TINUVIN 360 (available from Ciba Specialty Chemicals Corporation)

### <Matting Agent>

AEROSIL 200V (0.016-μm fine silica particles, available from Nippon Aerosil Co., Ltd.)

### [Production of Optical Film]

The cellulose acylates C-1, C-2, and C-3 were mixed in the same amounts. 8% of a plasticizer and 0.5% of a degradation inhibitor (an antioxidant) were added to the mixture, and the resultant was mixed for 30 minutes using a tumbler mixer.

The obtained mixture was dried at a hot air temperature of 150° C. and a dew point of −36° C. using a dehumidified hot air dryer DMZ2 manufactured by Matsui Universal Joint Corporation. Then, the mixture was introduced to a biaxial extruder manufactured by Technovel Corporation, and a matting agent was added thereto by a successive feeder from an opening of an additive hopper formed at the center of the extruder in an amount of 0.05% of the mixture to be extruded. Further, an ultraviolet absorber was added thereto from the opening in an amount of 0.5% of the mixture to be extruded, and then the resulting mixture was melt-extruded under conditions shown in Tables 2-3 and 2-4. The extruder had a coat hanger-type T die with a gap of 300 μm. The gap could be controlled by a movable bolt depending on the desired film thickness.

The melt-extruded film was dropped onto two chromium-plated, mirror-finished rolls having a temperature controlled at 120° C., and transported between three pulling rolls. An edge of the film was slit, and then the film was stretched under conditions shown in Tables 2-3 to 2-6. The results of evaluating each film are shown in Tables 2-7 and 2-8.

TABLE 2-1
Melt film forming method

| | Cellulose acrylate | | | | | |
|---|---|---|---|---|---|---|
| | | | | Number | | |
| | | | | average | | |
| | | | | molecular | Plasticizer | |
| | X | Y | | weight | | Amount |
| | Acetyl | Propionyl | Butyryl | (ten | | (% by |
| | group | group | group | thousand) | Type | mass) |
| Comparative | 1.9 | 0.8 | | 7 | A | 0 |
| Example 101 | | | | | | |
| Example 101 | 1.9 | 0.8 | | 7 | A | 2 |
| Example 102 | 1.9 | 0.8 | | 7 | A | 12 |
| Example 103 | 1.9 | 0.8 | | 7 | A | 18 |
| Comparative | 1.9 | 0.8 | | 7 | A | 22 |
| Example 102 | | | | | | |
| Comparative | 0.23 | 2.5 | | 6.6 | B | 19 |
| Example 103 | | | | | | |
| Example 104 | 0.23 | 2.5 | | 6.6 | B | 19 |
| Comparative | 2 | | 0.7 | 6.5 | C | 8.6 |
| Example 104 | | | | | | |
| Example 105 | 2 | | 0.7 | 6.5 | C | 8.6 |
| Example 106 | 2 | | 0.7 | 6.5 | C | 8.6 |
| Comparative | 2 | | 0.7 | 6.5 | C | 8.6 |
| Example 105 | | | | | | |
| Comparative | 1.9 | 0.8 | | 7 | D | 11 |
| Example 106 | | | | | | |
| Example 107 | 1.9 | 0.8 | | 7 | D | 11 |
| Example 108 | 1.9 | 0.8 | | 7 | D | 11 |
| Example 109 | 1.9 | 0.8 | | 7 | D | 11 |
| Example 110 | 1.9 | 0.8 | | 7 | D | 11 |
| Comparative | 1.9 | 0.8 | | 7 | D | 11 |
| Example 107 | | | | | | |

TABLE 2-2
Melt film forming method

| | Cellulose acylate | | | | | |
|---|---|---|---|---|---|---|
| | | | | Number | | |
| | | | | average | | |
| | | | | molecular | Plasticizer | |
| | X | Y | | weight | | Amount |
| | Acetyl | Propionyl | Butyryl | (ten | | (% by |
| | group | group | group | thousand) | Type | mass) |
| Comparative | 0.23 | 2.5 | | 6.6 | E | 15 |
| Example 108 | | | | | | |
| Example 111 | 0.23 | 2.5 | | 6.6 | E | 15 |
| Example 112 | 0.23 | 2.5 | | 6.6 | E | 15 |
| Example 113 | 0.23 | 2.5 | | 6.6 | E | 15 |
| Example 114 | 0.23 | 2.5 | | 6.6 | E | 15 |
| Comparative | 0.23 | 2.5 | | 6.6 | E | 15 |
| Example 109 | | | | | | |
| Comparative | 2 | | 0.7 | 6.5 | F | 15 |
| Example 110 | | | | | | |
| Example 115 | 2 | | 0.7 | 6.5 | F | 15 |
| Example 116 | 2 | | 0.7 | 6.5 | F | 15 |
| Comparative | 2 | | 0.7 | 6.5 | F | 15 |
| Example 111 | | | | | | |
| Example 117 | 2 | 0.8 | | 12 | B | 5 |
| Example 118 | 2 | 0.8 | | 12 | B | 5 |
| Example 119 | 2 | 0.8 | | 12 | B | 5 |
| Example 120 | 2 | 0.8 | | 12 | B | 5 |
| Example 121 | 2 | 0.8 | | 12 | B | 5 |
| Example 122 | 2 | 0.8 | | 12 | B | 5 |

TABLE 2-3
Melt film forming method

| | Flight-barrel | Longitudinal stretching | | | |
|---|---|---|---|---|---|
| | gap in | | | Peripheral | |
| | melt film | | Nip | speed | |
| | formation | | pressure | difference | Stretching |
| | (mm) | L/W | (MPa) | (%) | magnification |
| Comparative | 0.3 | Not longitudinally stretched | | | |
| Example 101 | | | | | |
| Example 101 | 0.3 | | | | |
| Example 102 | 0.3 | | | | |
| Example 103 | 0.3 | | | | |
| Comparative | 0.3 | | | | |
| Example 102 | | | | | |
| Comparative | 0.5 | 0.1 | 5 | 0.02 | 1.05 |
| Example 103 | | | | | |
| Example 104 | 0.5 | 0.1 | 5 | 0.02 | 1.05 |
| Comparative | 0.7 | 0.05 | 2 | 0.05 | 1.3 |
| Example 104 | | | | | |
| Example 105 | 0.7 | 0.05 | 2 | 0.05 | 1.3 |
| Example 106 | 0.7 | 0.05 | 2 | 0.05 | 1.3 |
| Comparative | 0.7 | 0.05 | 2 | 0.05 | 1.3 |
| Example 105 | | | | | |
| Comparative | 0.9 | 1.7 | 8 | 0.1 | 2.8 |
| Example 106 | | | | | |
| Example 107 | 0.9 | 2 | 8 | 0.1 | 2.8 |
| Example 108 | 0.9 | 15 | 8 | 0.1 | 2.8 |
| Example 109 | 0.9 | 15 | 8 | 0 | 2.8 |
| Example 110 | 0.9 | 48 | 8 | 0.1 | 2.8 |
| Comparative | 0.9 | 52 | 8 | 0.1 | 2.8 |
| Example 107 | | | | | |

TABLE 2-4
Melt film forming method

| | Flight- | | | | |
|---|---|---|---|---|---|
| | barrel | Longitudinal stretching | | | |
| | gap in | | | Peripheral | |
| | melt film | | Nip | speed | |
| | formation | | pressure | difference | Stretching |
| | (mm) | L/W | (MPa) | (%) | magnification |
| Comparative | 0.2 | 0.005 | 1 | 0.5 | 1.5 |
| Example 108 | | | | | |
| Example 111 | 0.2 | 0.02 | 1 | 0.5 | 1.5 |
| Example 112 | 0.2 | 0.02 | 1 | 0.5 | 1.5 |
| Example 113 | 0.2 | 0.02 | 1 | 0 | 1.5 |
| Example 114 | 0.2 | 0.28 | 1 | 0.5 | 1.5 |
| Comparative | 0.2 | 0.32 | 1 | 0.5 | 1.5 |
| Example 109 | | | | | |
| Comparative | 0.4 | 20 | 0.3 | 0.8 | 1.8 |
| Example 110 | | | | | |
| Example 115 | 0.4 | 20 | 0.6 | 0.8 | 1.8 |
| Example 116 | 0.4 | 20 | 8 | 0.8 | 1.8 |
| Comparative | 0.4 | 20 | 12 | 0.8 | 1.8 |
| Example 111 | | | | | |
| Example 117 | 0.8 | 0.05 | 3 | 0 | 1.5 |
| Example 118 | 0.8 | 0.05 | 3 | 0 | 1.5 |
| Example 119 | 0.8 | 0.05 | 3 | 0 | 1.5 |
| Example 120 | 0.8 | 0.05 | 3 | 0 | 1.5 |
| Example 121 | 0.8 | 0.05 | 3 | 1 | 1.5 |
| Example 122 | 1.2 | 0.05 | 3 | 1 | 1.5 |

TABLE 2-5
Melt film forming method

| | Preheating, transverse stretching, and heat-fixing | | | | | | | |
|---|---|---|---|---|---|---|---|---|
| | Zone temperature | | | Zone length ratio | | | Thermal relaxation | |
| | Preheating | Stretching | Heat-fixing | Preheating/ | Heat-fixing/ | Stretching | Temperature | Tension |
| | (° C.) | (° C.) | (° C.) | stretching | stretching | magnification | (° C.) | (kg/cm²) |
| Comparative | 130 | 120 | 110 | 2 | 2 | 2 | Tg + 10 | 5 |
| Example 101 | | | | | | | | |
| Example 101 | 130 | 120 | 110 | 2 | 2 | 2 | Tg + 10 | 5 |
| Example 102 | 130 | 120 | 110 | 2 | 2 | 2 | Tg + 10 | 5 |
| Example 103 | 130 | 120 | 110 | 2 | 2 | 2 | Tg + 10 | 5 |
| Comparative | 130 | 120 | 110 | 2 | 2 | 2 | Tg + 10 | 5 |
| Example 102 | | | | | | | | |
| Comparative | 140 | 150 | 150 | 6 | 4 | 2.8 | Tg | 3 |
| Example 103 | | | | | | | | |
| Example 104 | 150 | 140 | 150 | 6 | 4 | 2.8 | Tg | 3 |
| Comparative | 140 | 130 | 120 | 0.05 | 0.5 | 2 | Tg − 10 | 10 |
| Example 104 | | | | | | | | |
| Example 105 | 140 | 130 | 120 | 0.2 | 0.5 | 2 | Tg − 10 | 10 |
| Example 106 | 140 | 130 | 120 | 9 | 0.5 | 2 | Tg − 10 | 10 |
| Comparative | 140 | 130 | 120 | 12 | 0.5 | 2 | Tg − 10 | 10 |
| Example 105 | | | | | | | | |

| | | | |
|---|---|---|---|
| Comparative | Not transversely stretched | Tg + 5 | 7 |
| Example 106 | | | |
| Example 107 | | Tg + 5 | 7 |
| Example 108 | | Tg + 5 | 7 |
| Example 109 | | Tg + 5 | 7 |
| Example 110 | | Tg + 5 | 7 |
| Comparative | | Tg + 5 | 7 |
| Example 107 | | | |

TABLE 2-6
Melt film forming method

| | Preheating, transverse stretching, and heat-fixing | | | | | | | |
|---|---|---|---|---|---|---|---|---|
| | Zone temperature | | | Zone length ratio | | | Thermal relaxation | |
| | Preheating | Stretching | Heat-fixing | Preheating/ | Heat-fixing/ | Stretching | Temperature | Tension |
| | (° C.) | (° C.) | (° C.) | stretching | stretching | magnification | (° C.) | (kg/cm²) |
| Comparative | 160 | 140 | 120 | 0.5 | 3 | 1.5 | Tg − 5 | 15 |
| Example 108 | | | | | | | | |
| Example 111 | 160 | 140 | 120 | 0.5 | 3 | 1.5 | Tg − 5 | 15 |
| Example 112 | 160 | 140 | 120 | 0.5 | 3 | 1.5 | Tg − 5 | 15 |
| Example 113 | 160 | 140 | 120 | 0.5 | 3 | 1.5 | Tg − 5 | 15 |
| Example 114 | 160 | 140 | 120 | 0.5 | 3 | 1.5 | Tg − 5 | 15 |
| Comparative | 160 | 140 | 120 | 0.5 | 3 | 1.5 | Tg − 5 | 15 |
| Example 109 | | | | | | | | |
| Comparative | 170 | 130 | 120 | 4 | 1 | 1.1 | Tg + 15 | 5 |
| Example 110 | | | | | | | | |
| Example 115 | 170 | 130 | 120 | 4 | 1 | 1.1 | Tg + 15 | 5 |
| Example 116 | 170 | 130 | 120 | 4 | 1 | 1.1 | Tg + 15 | 5 |
| Comparative | 170 | 130 | 120 | 4 | 1 | 1.1 | Tg + 15 | 5 |
| Example 111 | | | | | | | | |
| Example 117 | 160 | 140 | 140 | 2 | 0.05 | 2.5 | Tg | 25 |
| Example 118 | 160 | 140 | 120 | 2 | 0.05 | 2.5 | Tg | 25 |
| Example 119 | 160 | 140 | 120 | 2 | 3 | 2.5 | Tg | 25 |
| Example 120 | 160 | 140 | 120 | 2 | 3 | 2.5 | Tg | 10 |
| Example 121 | 160 | 140 | 120 | 2 | 3 | 2.5 | Tg | 10 |
| Example 122 | 160 | 140 | 120 | 2 | 3 | 2.5 | Tg | 10 |

TABLE 2-7
Melt film forming method

| | Thickness | | Distribution of | | Distribution of | Thermal | Ratio of |
|---|---|---|---|---|---|---|---|
| | after | | Re change (ΔRe) | | Rth change (ΔRth) | shrinkage under | color |
| | stretching | Re | due to humidity | Rth | due to humidity | 40° C. and 95% rh | unevenness |
| | (μm) | (nm) | (%) | (nm) | (%) | (%) | (%) |
| Comparative | 80 | 220 | 36 | 190 | 38 | 0.18 | 38 |
| Example 101 | | | | | | | |
| Example 101 | 80 | 222 | 27 | 188 | 28 | 0.13 | 14 |
| Example 102 | 80 | 215 | 3 | 192 | 3 | 0.03 | 2 |
| Example 103 | 80 | 225 | 28 | 195 | 25 | 0.14 | 14 |
| Comparative | 80 | 217 | 34 | 194 | 35 | 0.18 | 44 |
| Example 102 | | | | | | | |
| Comparative | 60 | 220 | 35 | 255 | 36 | 0.19 | 43 |
| Example 103 | | | | | | | |
| Example 104 | 60 | 215 | 24 | 240 | 25 | 0.13 | 13 |
| Comparative | 40 | 80 | 33 | 260 | 35 | 0.18 | 39 |
| Example 104 | | | | | | | |
| Example 105 | 40 | 78 | 25 | 255 | 24 | 0.13 | 12 |
| Example 106 | 40 | 75 | 24 | 240 | 23 | 0.12 | 10 |
| Comparative | 40 | 82 | 33 | 255 | 34 | 0.18 | 39 |
| Example 105 | | | | | | | |
| Comparative | 100 | 310 | 34 | 145 | 36 | 0.19 | 44 |
| Example 106 | | | | | | | |
| Example 107 | 100 | 305 | 27 | 150 | 24 | 0.12 | 12 |
| Example 108 | 100 | 300 | 3 | 155 | 2 | 0.02 | 3 |
| Example 109 | 100 | 305 | 15 | 160 | 18 | 0.09 | 8 |
| Example 110 | 100 | 290 | 25 | 160 | 26 | 0.12 | 15 |
| Comparative | 100 | 295 | 34 | 155 | 35 | 0.17 | 42 |
| Example 107 | | | | | | | |

TABLE 2-8
Melt film forming method

| | Thickness | | Distribution of | | Distribution of | Thermal | Ratio of |
|---|---|---|---|---|---|---|---|
| | after | | Re change (ΔRe) | | Rth change (ΔRth) | shrinkage under | color |
| | stretching | Re | due to humidity | Rth | due to humidity | 40° C. and 95% rh | unevenness |
| | (μm) | (nm) | (%) | (nm) | (%) | (%) | (%) |
| Comparative | 50 | 18 | 36 | 290 | 37 | 0.18 | 44 |
| Example 108 | | | | | | | |
| Example 111 | 50 | 15 | 24 | 270 | 35 | 0.12 | 12 |
| Example 112 | 50 | 16 | 3 | 275 | 4 | 0.03 | 2 |
| Example 113 | 50 | 14 | 12 | 272 | 14 | 0.08 | 8 |
| Example 114 | 50 | 20 | 25 | 278 | 34 | 0.13 | 10 |
| Comparative | 50 | 17 | 35 | 282 | 35 | 0.19 | 45 |
| Example 109 | | | | | | | |
| Comparative | 70 | 198 | 36 | 210 | 36 | 0.19 | 45 |
| Example 110 | | | | | | | |
| Example 115 | 70 | 202 | 24 | 215 | 24 | 0.14 | 12 |
| Example 116 | 70 | 212 | 23 | 220 | 24 | 0.13 | 13 |
| Comparative | 70 | 195 | 36 | 210 | 37 | 0.19 | 46 |
| Example 111 | | | | | | | |
| Example 117 | 60 | 78 | 20 | 200 | 21 | 0.08 | 9 |
| Example 118 | 60 | 85 | 15 | 210 | 15 | 0.05 | 6 |
| Example 119 | 60 | 87 | 11 | 195 | 10 | 0.03 | 4 |
| Example 120 | 60 | 83 | 6 | 205 | 5 | 0.02 | 2 |
| Example 121 | 60 | 88 | 0 | 220 | 0 | 0 | 0 |
| Example 122 | 60 | 84 | 5 | 195 | 4 | 0.03 | 3 |

### (Production of Polarizing Plate)

A 120-μm-thick polyvinyl alcohol film was soaked in an aqueous solution containing 1% by mass of iodine, 2% by mass of potassium iodide, and 4% by mass of boric acid, and stretched at 50° C. at a 4-fold magnification, to obtain a polarizer.

Each of the above produced films was alkali-treated with a 2.5-M/L aqueous sodium hydroxide solution at 40° C. for 60 seconds, water-washed, and dried.

The alkali-treated surface of the film was attached to each surface of the polarizer using a bonding agent of a 5% aqueous solution of completely saponified polyvinyl alcohol, to prepare a polarizing plate having a protective film.

### (Evaluation of Properties in Liquid Crystal Display Device)

Polarizing plates on the surfaces of a 15-inch display VL-150SD manufactured by Fujitsu Ltd. were removed, and the above produced polarizing plate was cut into the size of the liquid crystal cell and attached to each glass surface.

Thus, two sheets of the above produced polarizing plates were attached such that their polarizing axes were perpendicular to each other without changing the polarizing axes of the original polarizing plates peeled, to obtain a liquid crystal display device.

The displaying unevenness due to environmental humidity change of the liquid crystal display device was measured in the same manner as above. The results are shown in Tables 2-7 and 2-8.

### Examples 201 to 209 and Comparative Examples 201

### Melt Film Forming Method

Cellulose acylates C-5 to C-8 were synthesized according to Synthesis Example 5-8 of Japanese Laid-Open Patent Publication No. 2007-326359. As shown in Table 3-1, 15% by weight of 2-1 of Chemical Formula 2, 3-1 of Chemical Formula 18, 4-1 of Chemical Formula 30, or 3-6 of Chemical Formula 18 illustrated in Japanese Laid-Open Patent Publication No. 2007-326359 was added to 100 parts by weight of each cellulose acylate. Further, 0.5 parts by mass of a stabilizer IRGANOX-1010 available from Ciba Specialty Chemicals Corporation, 1.0 part by mass of an ultraviolet absorber TINUVIN 928 available from Ciba Specialty Chemicals Corporation, and 0.3 parts by mass of a matting agent AEROSIL R972V were mixed therewith, and the mixture was dried under a reduced pressure at 60° C. for 5 hours. Thus obtained cellulose acylate composition was melted and mixed at 235° C. by using a biaxial extruder, to prepare a pellet. In this process, a kneading disc was not used, but an all-screw type device was used in order to prevent heat generation due to kneading shear. Further, the device was vacuated through a vent to remove volatile components generated in the kneading. The obtained cellulose acylate composition was transported from a feeder or hopper for the extruder through an extruder die to a cooling bath under dry nitrogen gas while preventing moisture absorption of the resin.

The pellet (water content 50 ppm) was cast at a melt film forming temperature of 240° C. at a melt extrusion draw ratio of 20 from a casting die onto a first cooling roll having a surface temperature of 130° C. by using a uniaxial extruder, to obtain a cast film. The casting die had a lip clearance of 1.5 mm and an average lip surface roughness Ra of 0.01 μm. In the extruder, the gap between a flight (a hill) and a barrel was controlled as shown in Table 3-2.

First and second cooling rolls having a diameter of 40 cm, composed of a stainless steel, were hard chrome-plated. Further, a temperature controlling oil was circulated in each roll to control the roll surface temperature. An elastically deformable touch roll having a diameter of 20 cm was used. The touch roll had inner and outer cylinders composed of a stainless steel, and the surface of the outer cylinder was hard chrome-plated. The outer cylinder had a thickness of 2 mm, and a temperature controlling oil was circulated in a space between the inner and outer cylinders to control the elastically deformable touch roll surface temperature.

The film was nipped at a linear pressure of 10 kg/cm onto the first cooling roll by the elastic touch roll having a 2 mm-thick metal surface. In this nipping step, a surface of the film, facing to the touch roll, had a temperature of 180±1° C. The surface temperature of the film was obtained as follows. Ten portions arranged in the width direction of the film were selected in a region, in which the touch roll was nipped with the first cooling roll. The touch roll was removed, and the temperatures of the ten portions were measured using a noncontact thermometer from a position at a 50-cm distance from the portions. Then, the average of the temperatures were calculated as the surface temperature of the film. In this example, the film had a glass transition temperature Tg of 136° C. The glass transition temperature Tg of the film extruded from the die was measured by a DSC method (under nitrogen, heating rate 10° C./minute) using DSC6200 manufactured by Seiko Instruments Inc.

The elastically deformable touch roll had a surface temperature of 130° C. The temperature difference between the first and second cooling rolls is shown in Table 3-2. The surface temperature of each of the elastic touch roll and the first and second cooling rolls was obtained as follows. Ten portions arranged in the width direction of the roll were selected in a region that was tilted against the direction of rotation by 90° from a region in which the film was brought in contact with the roll first. The temperatures of the ten portions were measured using a noncontact thermometer, the average of the temperatures were calculated as the surface temperature of the roll. The unstretched film had a residual solvent content of 0% by weight, and was stretched under conditions shown in Tables 3-2 and 3-3. The longitudinal stretching step was carried out at 160° C. The results of evaluating the film are shown in Table 3-4.

TABLE 3-1

| | Cellulose acylate | | | | | |
|---|---|---|---|---|---|---|
| | | | | Weight | | |
| | | | | average | | |
| | | | | molecular | Plasticizer | |
| | | X | Y | weight | | Amount |
| | | Acetyl | Propionyl | (ten | | (% by |
| | Resin* | group | group | thousand) | Type | mass) |
| Example 201 | C-5 | 1.65 | 1.27 | 23.8 | 2-1** | 15 |
| Example 202 | C-5 | 1.65 | 1.27 | 23.8 | 2-1** | 15 |
| Example 203 | C-5 | 1.65 | 1.27 | 23.8 | 2-1** | 15 |
| Example 204 | C-5 | 1.65 | 1.27 | 23.8 | 2-1** | 15 |
| Example 205 | C-5 | 1.65 | 1.27 | 23.8 | 2-1** | 15 |
| Comparative | C-5 | 1.65 | 1.27 | 23.8 | 2-1** | 15 |
| Example 201 | | | | | | |
| Example 206 | C-5 | 1.65 | 1.27 | 23.8 | 3-1** | 15 |
| Example 207 | C-6 | 1.45 | 1.43 | 24.1 | 3-1** | 12 |
| Example 208 | C-7 | 0.35 | 2.2 | 22.3 | 4-1** | 10 |
| Example 209 | C-8 | 0.15 | 2.73 | 24.8 | 3-6** | 8 |

Resin*:
Cellulose acylate compounds shown in Table 1 of
Japanese Laid-Open Patent Publication No. 2007-326359.
Plasticizer (Type)**:
2-1 of Chemical Formula 2 illustrated
in Japanese Laid-Open Patent Publication No. 2007-326359.
2-1

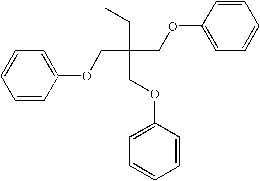

3-1 of Chemical Formula 18 illustrated in Japanese Laid-Open
Patent Publication No. 2007-326359.
3-1

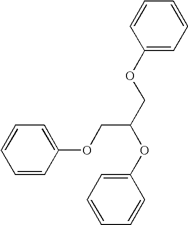

4-1 of Chemical Formula 30 illustrated in Japanese Laid-Open
Patent Publication No. 2007-326359.
4-1

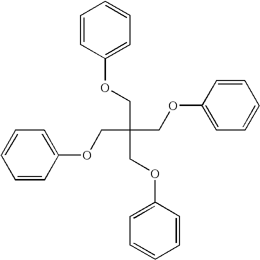

3-6 of Chemical Formula 18 illustrated in Japanese Laid-Open
Patent Publication No. 2007-326359.
3-6

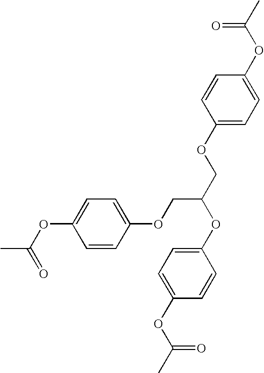

TABLE 3-2

| | Melt film forming method | | | | | |
|---|---|---|---|---|---|---|
| | | First cooling | | | | |
| | Flight- | roll temperature − | Longitudinal stretching | | | |
| | barrel | Second cooling | | Nip | Peripheral speed | |
| | gap | roll temperature | | pressure | difference | Stretching |
| | (mm) | (° C.) | L/W | (MPa) | (%) | magnification |
| Example 201 | 0.3 | 0 | 0.1 | 4 | 0.08 | 1.05 |
| Example 202 | 0.3 | 1 | 0.1 | 4 | 0.08 | 1.05 |
| Example 203 | 0.3 | 10 | 0.1 | 4 | 0.08 | 1.05 |
| Example 204 | 0.3 | 29 | 0.1 | 4 | 0.08 | 1.05 |
| Example 205 | 0.3 | 30 | 0.1 | 4 | 0.08 | 1.05 |
| Comparative | 0.08 | 30 | 0.8 | 12 | 0 | 1.05 |
| Example 201 | | | | | | |
| Example 206 | 0.3 | 10 | 0.1 | 4 | 0.08 | 1.05 |
| Example 207 | 0.3 | 10 | 0.1 | 4 | 0.08 | 1.05 |
| Example 208 | 0.3 | 10 | 0.1 | 4 | 0.08 | 1.05 |
| Example 209 | 0.3 | 10 | 0.1 | 4 | 0.08 | 1.05 |

TABLE 3-3

| | Preheating, transverse stretching, and heat-fixing | | | | | | | |
|---|---|---|---|---|---|---|---|---|
| | Zone temperature | | | Zone length ratio | | | Thermal relaxation | |
| | Preheating | Stretching | Heat-fixing | Preheating/ | Heat-fixing/ | Stretching | Temperature | Tension |
| | (° C.) | (° C.) | (° C.) | stretching | stretching | magnification | (° C.) | (kg/cm²) |
| Example 201 | 170 | 160 | 140 | 2 | 2 | 1.2 | Tg + 10 | 5 |
| Example 202 | 170 | 160 | 140 | 2 | 2 | 1.2 | Tg + 10 | 5 |
| Example 203 | 170 | 160 | 140 | 2 | 2 | 1.2 | Tg + 10 | 5 |
| Example 204 | 170 | 160 | 140 | 2 | 2 | 1.2 | Tg + 10 | 5 |
| Example 205 | 170 | 160 | 140 | 2 | 2 | 1.2 | Tg + 10 | 5 |
| Comparative | 160 | 160 | 160 | 11 | 11 | 1.2 | Tg − 30 | 22 |
| Example 201 | | | | | | | | |
| Example 206 | 170 | 160 | 140 | 2 | 2 | 1.2 | Tg + 10 | 5 |
| Example 207 | 170 | 160 | 140 | 2 | 2 | 1.2 | Tg + 10 | 5 |
| Example 208 | 170 | 160 | 140 | 2 | 2 | 1.2 | Tg + 10 | 5 |
| Example 209 | 170 | 160 | 140 | 2 | 2 | 1.2 | Tg + 10 | 5 |

TABLE 3-4

| | Thickness | | Distribution of | | Distribution of | Thermal | Ratio of |
|---|---|---|---|---|---|---|---|
| | after | | Re change (ΔRe) | | Rth change (ΔRth) | shrinkage under | color |
| | stretching | Re | due to humidity | Rth | due to humidity | 40° C. and 95% rh | unevenness |
| | (μm) | (nm) | (%) | (nm) | (%) | (%) | (%) |
| Example 201 | 80 | 4 | 20 | 47 | 22 | 0.12 | 10 |
| Example 202 | 80 | 5 | 10 | 45 | 9 | 0.06 | 3 |
| Example 203 | 80 | 5 | 6 | 44 | 5 | 0.02 | 0 |
| Example 204 | 80 | 4 | 12 | 46 | 10 | 0.07 | 4 |
| Example 205 | 80 | 5 | 22 | 45 | 19 | 0.11 | 10 |
| Comparative | 80 | 4 | 43 | 45 | 42 | 0.22 | 55 |
| Example 201 | | | | | | | |
| Example 206 | 80 | 5 | 8 | 44 | 7 | 0.04 | 1 |
| Example 207 | 80 | 8 | 7 | 65 | 6 | 0.12 | 1 |
| Example 208 | 80 | 30 | 8 | 90 | 7 | 0.03 | 1 |
| Example 209 | 80 | 15 | 8 | 50 | 8 | 0.14 | 1 |

### (Production of Polarizing Plate)

The above produced cellulose acylate film was subjected to the following alkali saponification treatment, to produce a polarizing plate.

### (Alkali Saponification Treatment)

Saponification step: 2-mol/L aqueous NaOH solution, 50° C., 90 seconds
Water washing step: water, 30° C., 45 seconds
Neutralization step: 10%-by-mass aqueous HCl solution, 30° C., 45 seconds
Water washing step: water, 30° C., 45 seconds

After the saponification step, the water washing step, the neutralization step, and the water washing step were carried out in this order, and the resultant film was dried at 80° C.

### (Production of Polarizer)

A 120-μm-thick, long-roll, polyvinyl alcohol film was soaked in 100 parts by mass of an aqueous solution containing 1 part by mass of iodine and 4 parts by mass of boric acid, and stretched in the transporting direction at 50° C. at a 6-fold magnification, to obtain a polarizer.

The alkali-saponified surface of the above cellulose acylate film was attached to each surface of the polarizer using a bonding agent of a 5%-by-mass aqueous solution of completely saponified polyvinyl alcohol, to prepare a polarizing plate having a protective film.

### (Evaluation of Properties in Liquid Crystal Display Device)

Polarizing plates on a 32-inch, TFT-type, color liquid crystal display VEGA manufactured by Sony Corporation were removed. Two sheets of the above produced polarizing plates were cut into the size of a liquid crystal cell of the display, and attached to the liquid crystal cell such that their polarizing axes were perpendicular to each other without changing the polarizing axes of the original polarizing plates peeled. Thus, the liquid crystal cell was sandwiched between the two polarizing plates, to obtain a liquid crystal display device. The displaying unevenness due to environmental humidity change of the liquid crystal display device was measured in the same manner as above. The results are shown in Tables 3-4.

As a result, the devices produced according to the present invention had excellent properties. Thus, by controlling the temperature difference between the first and second cooling rolls to 1° C. to 29° C., the films having more excellent properties could be produced (Examples 201 to 205). Further, the compound of 2-1 could be suitably used as the plasticizer (Examples 203 and 206). Furthermore, excellent results could be obtained even in Examples 207 to 209 using different plasticizers and acyl substitution degrees. In contrast, the film of Comparative Example 201, produced in the same manner as a film F-5 described in Examples of Japanese Laid-Open Patent Publication No. 2007-326359, exhibited an increased displaying unevenness due to environmental humidity change.

Further, as compared with films F-5 to F-8, F-11 to F-13, F-15 to F-17, F-19 to F-25, F-27 to F-32, and F-34 to F-39 described in Examples of Japanese Laid-Open Patent Publication No. 2007-326359, the film of Example 203 advantageously exhibited a smaller displaying unevenness due to environmental humidity change.

Although certain preferred embodiments of the present invention have been shown and described in detail, it should be understood that various changes and modifications may be made therein without departing from the scope of the appended claims.

What is claimed is:

1. A method for producing a cellulose acylate film, comprising the step of transversely stretching a cellulose acylate film under conditions of [preheating temperature>stretching temperature] and [preheating zone length/stretching zone length=0.1 to 10], wherein
said cellulose acylate film contains 1% to 25% by mass of a plasticizer and has a cellulose acylate composition satisfying the inequalities of 0≦X≦2.5 and 2.1≦X+Y≦3.0 (in which X is a substitution degree of acetyl group, and Y is a substitution degree of at least one group selected from propionyl, butyryl, and phthaloyl groups).

2. A method according to claim 1, further comprising the step of, after the transversely stretching step, heat-fixing said film under conditions of [stretching temperature>heat-fixing temperature] and [heat-fixing zone length/stretching zone length=0.1 to 10].

3. A method according to claim 1, further comprising the step of longitudinally stretching said cellulose acylate film at a length/width ratio (L/W) of more than 2 and at most 50, or more than 0.01 and less than 0.3, using at least two pairs of nip rolls at a nip pressure of 0.5 to 10 MPa.

4. A method according to claim 1, further comprising the step of, after the stretching step, subjecting said film to a relaxation treatment while transporting said film at a temperature of Tg−20° C. to Tg+20° C. (in which Tg is the glass transition temperature of said film) at a tension of 1 to 20 kg/cm².

5. A method according to claim 1, wherein said film has a residual solvent content of 1% by mass or less in the steps of preheating, stretching, heat-fixing, and relaxation treatment.

6. A method according to claim 1, wherein said cellulose acylate film is prepared by a melt casting method containing an extrusion step using a screw, the gap between a flight of the screw and a barrel being 0.1 to 10 mm.

7. A method according to claim 6, wherein, in said melt casting method, a melt is extruded from a casting die, nipped between a first cooling roll and an elastically deformable touch roll, and transported through a second cooling roll, and the temperature of said second cooling roll is lower than that of said first cooling roll by 1° C. to 29° C.

8. A method according to claim 1, wherein said cellulose acylate film is prepared by a solution cast film forming method using a band having a thickness of 0.5 to 2 mm.

9. A method according to claim 1, wherein said cellulose acylate film has a thickness of 20 to 100 μm after the stretching step.

10. A method for producing a cellulose acylate film, comprising the step of longitudinally stretching a cellulose acylate film at a length/width ratio (L/W) of more than 2 and at most 50, using at least two pairs of nip rolls at a nip pressure of 0.5 to 10 MPa, wherein said cellulose acylate film contains 1% to 25% by mass of a plasticizer and has a cellulose acylate composition satisfying the inequalities of 0≦X≦2.5 and 2.1≦X+Y≦3.0 (in which X is a substitution degree of acetyl group, and Y is a substitution degree of at least one group selected from propionyl, butyryl, and phthaloyl groups).

11. A method according to claim 10, wherein at least one pair of said nip rolls has a peripheral speed difference of 0.01% to 1%.

12. A method for producing a cellulose acylate film, comprising the step of longitudinally stretching a cellulose acylate film at a length/width ratio (L/W) of more than 0.01 and less than 0.3, using at least two pairs of nip rolls at a nip pressure of 0.5 to 10 MPa, wherein
said film contains 1% to 25% by mass of a plasticizer and has a cellulose acylate composition satisfying the inequalities of 0≦X≦2.5 and 2.1≦X+Y≦3.0 (in which X is a substitution degree of acetyl group, and Y is a substitution degree of at least one group selected from propionyl, butyryl, and phthaloyl groups).

13. A method according to claim 12, wherein at least one pair of said nip rolls has a peripheral speed difference of 0.01% to 1%.

14. A cellulose acylate film, which exhibits 0.15% or less of dimensional change due to heat and humidity at 40° C. and 95% relative humidity for 1 day, and 30% or less of distributions of Re and Rth changes (ΔRe and ΔRth) due to humidity.

15. A cellulose acylate film according to claim 14, obtained by transversely stretching a cellulose acylate film under conditions of [preheating temperature>stretching temperature] and [preheating zone length/stretching zone length=0.1 to 10], wherein
said film contains 1% to 25% by mass of a plasticizer and has a cellulose acylate composition satisfying the inequalities of 0≦X≦2.5 and 2.1≦X+Y≦3.0 (in which X is a substitution degree of acetyl group, and Y is a substitution degree of at least one group selected from propionyl, butyryl, and phthaloyl groups).

16. A cellulose acylate film according to claim 14, obtained by longitudinally stretching a cellulose acylate film at a length/width ratio (L/W) of more than 2 and at most 50 using at least two pairs of nip rolls at a nip pressure of 0.5 to 10 MPa, wherein
said film contains 1% to 25% by mass of a plasticizer and has a cellulose acylate composition satisfying the inequalities of 0≦X≦2.5 and 2.1≦X+Y≦3.0 (in which X is a substitution degree of acetyl group, and Y is a substitution degree of at least one group selected from propionyl, butyryl, and phthaloyl groups).

17. A cellulose acylate film according to claim 14, obtained by longitudinally stretching a cellulose acylate film at a length/width ratio (L/W) of more than 0.01 and less than 0.3 using at least two pairs of nip rolls at a nip pressure of 0.5 to 10 MPa, wherein
said film contains 1% to 25% by mass of a plasticizer and has a cellulose acylate composition satisfying the inequalities of 0≦X≦2.5 and 2.1≦X+Y≦3.0 (in which X is a substitution degree of acetyl group, and Y is a substitution degree of at least one group selected from propionyl, butyryl, and phthaloyl groups).
